(19) United States
(12) Patent Application Publication
(10) Pub. No.: US 2026/0078063 A1
(43) Pub. Date: Mar. 19, 2026

(54) COMPOSITE PARTICLES AND METHODS OF MANUFACTURE THEREOF

(71) Applicant: Aspen Aerogels, Inc., Northborough, MA (US)

(72) Inventors: Zhifei Li, Marlborough, MA (US); Nicholas Zafiropoulos, Wayland, MA (US); Ted Hosang Lee, Marlborough, MA (US); Justin Ward, Northborough, MA (US); Ryan Fedora, Northborough, MA (US)

(73) Assignee: Aspen Aerogels, Inc., Northborough, MA (US)

(21) Appl. No.: 19/400,639

(22) Filed: Nov. 25, 2025

Related U.S. Application Data
(63) Continuation of application No. PCT/IB2024/055305, filed on May 30, 2024.
(60) Provisional application No. 63/504,932, filed on May 30, 2023.

(51) Int. Cl. C04B 35/532; C04B 35/624; C04B 35/626; C04B 35/634; C04B 35/64; H01M 4/36; H01M 4/587

(52) U.S. Cl. CPC C04B 35/532; C04B 35/624; C04B 35/6264; C04B 35/63448; C04B 35/64; H01M 4/362; H01M 4/587; C04B 2235/422; C04B 2235/428; C04B 2235/48

(57) ABSTRACT

The present disclosure is generally directed to composite particles which include a matrix material having an innate matrix porosity having matrix pores; and a plurality of additive particles disposed within the matrix material. The present disclosure is further directed to methods of preparing such composite particles.

### CROSS-REFERENCE TO RELATED APPLICATIONS

This application is a continuation of International Application No. PCT/IB2024/055305, filed May 30, 2024, which claims priority to U.S. Provisional Patent Application No. 63/504,932, filed May 30, 2023, each of which are herein incorporated by reference in their entirety.

### TECHNICAL FIELD

The present disclosure relates generally to composite particles comprising a matrix material and a plurality of sacrificial particles, functional particles, or both disposed within the matrix material, and to processes for making the same.

### BACKGROUND

Lithium-ion batteries (LIBs) have seen widespread use in a variety of applications, from handheld electronics to automobiles. They are a type of rechargeable battery in which lithium ions travel from an anode to a cathode during discharge and from the cathode to the anode during charge. Characteristics of electrodes can dramatically affect the performance and safety characteristics of LIBs. Graphite is widely used as an anode active material owing to its high specific capacity, low electrochemical potential vs. lithium, and ability for form a stable Solid Electrolyte Interphase (SEI). Nevertheless, there is a commercial demand for LIB anode materials that have a higher lithium storage capacity than is obtainable with graphite. Recently, there has been effort devoted to the development and characterization of composite materials comprising electroactive species (e.g., silicon) as electrode materials with improved performance for applications in energy storage devices, such as LIBs. Silicon (Si) has a lithium storage capacity greater than graphite and low electrochemical potential vs lithium, making it desirable for LIB anodes. Accordingly, there is a desire to dispose as much silicon as possible within the anode. However, during cycling, conventional silicon materials undergo volumetric expansion and contraction due to insertion and removal of lithium ions. These stresses can lead to fracture of the silicon material, potentially leading to pulverization of the anode and a decrease in the service life of the LIB.

Accordingly, it would be desirable in the art to provide composite materials including an electroactive species which maintain low electrical resistance and accommodate expansion of the electroactive species without causing the corresponding electrode to crack and delaminate. Further, it would be desirable in the art to provide methods for preparing such improved composite materials.

### SUMMARY

The present technology is generally directed to composite materials for use in battery electrodes and methods of preparation thereof, as well as batteries comprising such electrodes. Specifically, the technology is directed to composite particles comprising a matrix material and a plurality of particles (sacrificial, functional, or both) disposed within the matrix material. In some embodiments, following exposure to elevated temperature, any sacrificial particles present in the composite particles are converted into shaped pores. These shaped pores accommodate expansion of electroactive species such as silicon. The present technology is further directed to methods of preparation of such composite particles. As described herein below, it has been surprisingly found according to the present disclosure that the density of the composite particles and the distribution of functional and/or sacrificial particles within the interior and surface of the particles may be modulated by the timing of addition of gelation agent, the amount of gelation agent added, and the specific gelation agent type (e.g., acid or anhydride).

Accordingly, in one aspect is provided a composite particle comprising: a matrix material having an innate matrix porosity comprising matrix pores; and a plurality of additive particles disposed within the matrix material, wherein an exterior surface region of the composite particle contains a greatest percentage by volume of the matrix material.

In some embodiments, the composite particle comprises a central region extending from a center of the composite particle outward toward the exterior surface region, wherein the central region comprises additive particles. In some embodiments, the exterior surface region, including the exterior surface, comprises additive particles.

In some embodiments, the additive particles comprise functional particles and sacrificial particles.

In some embodiments, the matrix material comprises shaped pores formed by the thermal decomposition of at least a portion of the sacrificial particles.

In some embodiments, an amount of the shaped pores present is determined by an amount of the sacrificial particles present in the matrix material prior to the thermal decomposition thereof.

In some embodiments, the shaped pores have a diameter from about 0.1 times to about 1 time the diameter of the matrix pores.

In some embodiments, the shaped pores have a diameter from about 1 to about 50,000 times the diameter of the matrix pores.

In some embodiments, the shaped pores have a diameter in a range from about 0.05 μm to about 15 μm.

In some embodiments, the shaped pores are spherical pores or distorted spherical pores.

In some embodiments, the shaped pores are connected to the matrix pores.

In some embodiments, at least a portion of the functional particles are positioned adjacent to the shaped pores.

In some embodiments, the functional particles each have a volume, the shaped pores each have a volume, and the matrix pores each have a volume, and the volume of each functional particle is less than the volume of a shaped pore and greater than the volume of a matrix pore.

In some embodiments, the functional particles are electrochemically active.

In some embodiments, the functional particles comprise silicon.

In some embodiments, the functional particles comprise a sacrificial coating.

In some embodiments, the composite particle comprises void space surrounding the functional particles, the void space formed by the thermal decomposition of a sacrificial coating.

In some embodiments, the exterior surface region has a thickness in a range from about 0.1% to about 25% of the diameter of the composite particle. In some embodiments, a thickness of the exterior surface region varies along an exterior surface of the composite particle.

In some embodiments, the composite particle has a total volume of the shaped pores and a total volume of the functional particles, and wherein the total volume of the functional particles is less than the total volume of the shaped pores.

In some embodiments, the total volume of the shaped pores is about 0.1 to about 10 times the total volume of the functional particles.

In some embodiments, the composite particle comprises surface depressions projecting from an outer surface of the particle into the exterior surface region, and wherein said surface depressions comprise one or more functional particles.

In some embodiments, the matrix material comprises carbon.

In some embodiments, the matrix material is formed by the thermal decomposition of an organogel material.

In another aspect is provided a composite particle comprising: a matrix material having an innate matrix porosity comprising matrix pores; and
(i) a plurality of functional additive particles disposed within the matrix material and a plurality of sacrificial additive particles disposed within the matrix material;
(ii) a plurality of voids disposed within the matrix material, said voids formed by the thermal decomposition of sacrificial additive particles; or
(iii) a combination of a plurality of functional additive particles disposed within the matrix material and a plurality of voids disposed within the matrix material, said voids formed by the thermal decomposition of sacrificial additive particles,
   wherein an exterior surface region of the composite particle contains a greatest percentage by volume of the matrix material.

In some embodiments, the composite particle comprises an exterior surface region and a central region, the central region extending from a center of the composite particle outward toward the exterior surface region, wherein the central region comprises the plurality of functional additive particles and the plurality of sacrificial additive particles, the plurality of voids, or the combination of the plurality of functional additive particles and the plurality of voids.

In some embodiments, the exterior surface region, including an exterior surface, comprises additive particles.

In some embodiments, an amount of the voids present is determined by an amount of the sacrificial particles present in the matrix material prior to the thermal decomposition thereof.

In some embodiments, the voids are shaped pores.

In some embodiments, the shaped pores have a diameter from about 0.1 times to about 1 time the diameter of the matrix pores.

In some embodiments, the shaped pores have a diameter from about 1 to about 50,000 times the diameter of the matrix pores.

In some embodiments, the shaped pores have a diameter in a range from about 0.05 μm to about 15 μm.

In some embodiments, the shaped pores are spherical pores or distorted spherical pores.

In some embodiments, the shaped pores are connected to the matrix pores.

In some embodiments, at least a portion of the functional particles are positioned adjacent to the shaped pores.

In some embodiments, the functional particles each have a volume, the shaped pores each have a volume, and the matrix pores each have a volume, and wherein the volume of each functional particle is less than the volume of a shaped pore and greater than the volume of a matrix pore.

In some embodiments, the functional particles are electrochemically active.

In some embodiments, the functional particles comprise silicon, germanium, tin, or a combination thereof.

In some embodiments, the functional particles comprise a sacrificial coating.

In some embodiments, the composite particle comprises a void space surrounding the functional particles formed by the thermal decomposition of a sacrificial coating.

In some embodiments, the exterior surface region has a thickness in a range from about 0.1% to about 25% of the diameter of the composite particle. In some embodiments, a thickness of the exterior surface region varies along an exterior surface of the composite particle.

In some embodiments, the volume of the composite particle is composed of a total volume of the shaped pores, a total volume of the functional particles and a total volume of the matrix material, and wherein the total volume of the functional particles is less than the total volume of the shaped pores. In some embodiments, the total volume of the shaped pores is about 0.1 to about 10 times the total volume of the functional particles.

In some embodiments, the composite particle comprises surface depressions projecting from an outer surface of the particle into the exterior surface region, and wherein said surface depressions comprise one or more functional particles.

In some embodiments, the matrix material comprises carbon.

In some embodiments, the matrix material is formed by the thermal decomposition of an organogel material.

In another aspect is provided a composite particle comprising:
a matrix material extending from a center of the composite particle to an exterior surface of the composite particle and forming a three-dimensional network, the matrix material having an innate matrix porosity comprising matrix pores;
a plurality of additive particles dispersed heterogeneously within the matrix material; and
an inner region extending outward from the center to an outer region, said outer region extending outward from the inner region to the exterior surface,
wherein said inner and outer regions are defined by a population density of additive particles, the inner region having a higher population density of additive particles relative to the outer region.

In some embodiments, the exterior surface region, including the exterior surface, comprises additive particles.

In some embodiments, the additive particles comprise functional particles and sacrificial particles.

In some embodiments, the matrix material comprises shaped pores formed by the thermal decomposition of at least a portion of the sacrificial particles.

In some embodiments, an amount of the shaped pores present is determined by an amount of the sacrificial particles present in the matrix material prior to the thermal decomposition thereof.

In some embodiments, the shaped pores have a diameter from about 0.1 times to about 1 time the diameter of the matrix pores.

In some embodiments, the shaped pores have a diameter from about 1 to about 50,000 times the diameter of the matrix pores.

In some embodiments, the shaped pores have a diameter in a range from about 0.05 μm to about 15 μm.

In some embodiments, the shaped pores are spherical pores or distorted spherical pores.

In some embodiments, the shaped pores are connected to the matrix pores.

In some embodiments, at least a portion of the functional particles are positioned adjacent to the shaped pores.

In some embodiments, the functional particles each have a volume, the shaped pores each have a volume, and the matrix pores each have a volume, and wherein the volume of each functional particle is less than the volume of a shaped pore and greater than the volume of a matrix pore.

In some embodiments, the functional particles are electrochemically active.

In some embodiments, the functional particles comprise silicon.

In some embodiments, the functional particles comprise a sacrificial coating.

In some embodiments, the composite particle comprises void space surrounding the functional particles, the void space formed by the thermal decomposition of a sacrificial coating.

In some embodiments, the exterior surface region has a thickness in a range from about 0.1% to about 25% of the diameter of the composite particle.

In some embodiments, a thickness of the exterior surface region varies along an exterior surface of the composite particle.

In some embodiments, the composite particle has a total volume of the shaped pores and a total volume of the functional particles, and wherein the total volume of the functional particles is less than the total volume of the shaped pores.

In some embodiments, the total volume of the shaped pores is about 0.1 to about 10 times greater than the total volume of the functional particles.

In some embodiments, the composite particle comprises surface depressions projecting from an outer surface of the particle into the exterior surface region, and wherein said surface depressions comprise one or more functional particles.

In some embodiments, the matrix material comprises carbon.

In some embodiments, the matrix material is formed by the thermal decomposition of an organogel material.

In a still further aspect is provided a composite particle comprising:
a matrix material having an innate matrix porosity comprising matrix pores; and
   a plurality of functional additive particles disposed within the matrix material and a plurality of sacrificial additive particles disposed within the matrix material;
   a plurality of voids disposed within the matrix material, said voids formed by the thermal decomposition of sacrificial additive particles; or
   a combination of a plurality of functional additive particles disposed within the matrix material and a plurality of voids disposed within the matrix material, said voids formed by the thermal decomposition of sacrificial additive particles.

In some embodiments, an amount of the voids present is determined by an amount of the sacrificial particles present in the matrix material prior to the thermal decomposition thereof.

In some embodiments, the voids are shaped pores.

In some embodiments, the shaped pores have a diameter from about 0.1 times to about 1 time the diameter of the matrix pores.

In some embodiments, the shaped pores have a diameter from about 1 time to about 50,000 times the diameter of the matrix pores.

In some embodiments, the shaped pores have a diameter in a range from about 0.05 μm to about 15 μm.

In some embodiments, the shaped pores are spherical pores or distorted spherical pores.

In some embodiments, the shaped pores are connected to the matrix pores.

In some embodiments, at least a portion of the functional particles are positioned adjacent to the shaped pores.

In some embodiments, the functional particles each have a volume, the shaped pores each have a volume, and the matrix pores each have a volume, and wherein the volume of each functional particle is less than the volume of a shaped pore and greater than the volume of a matrix pore.

In some embodiments, the functional particles are electrochemically active.

In some embodiments, the functional particles comprise silicon, germanium, tin, or a combination thereof.

In some embodiments, the functional particles comprise a sacrificial coating.

In some embodiments, the composite particle comprises void space surrounding the functional particles formed by the thermal decomposition of a sacrificial coating.

In some embodiments, the composite particle has a total volume of the shaped pores and a total volume of the functional particles, and wherein the total volume of the functional particles is less than the total volume of the shaped pores.

In some embodiments, the total volume of the shaped pores is about 0.1 times to about 10 times greater than the total volume of the functional particles.

In some embodiments, the composite particle comprises surface depressions projecting inward from an outer surface of the particle, and wherein said surface depressions comprise one or more functional particles.

In some embodiments, the matrix material comprises carbon.

In some embodiments, the matrix material is formed by the thermal decomposition of an organogel material.

In another aspect is provided an electrode for a battery comprising a composite particle as disclosed herein.

In another aspect is provided an electric vehicle, an energy storage system, or an electronic device comprising the electrode.

In another aspect is provided a battery cell, battery module, or battery pack comprising a composite particle as disclosed herein.

In yet another aspect is provided a method of preparing composite particles comprising a matrix material and a plurality of sacrificial particles disposed within the matrix material, and wherein the composite particles comprise an exterior surface region, the method comprising:
providing a solution of one or more matrix material precursors in a solvent;
suspending sacrificial particles in the solution to form a suspension;
combining the suspension with an immiscible liquid to form a mixture;
emulsifying the mixture to provide a plurality of droplets, wherein each droplet in the plurality comprises a plurality of the sacrificial particles;
adding a gelation agent to the emulsified mixture, forming organogel particles from each droplet; and
optionally, drying the organogel particles.

In a yet further aspect is provided a method of preparing composite particles comprising a matrix material and a plurality of sacrificial particles disposed within the matrix material, and wherein the composite particles comprise an exterior surface region, the method comprising:
providing a solution of one or more matrix material precursors in a solvent;
optionally, suspending functional particles in the solution;
adding a portion of a total amount of a gelation agent to the solution, initiating formation of an organogel;
suspending sacrificial particles in the solution to form a suspension;
combining the suspension with an immiscible liquid to form a mixture;
emulsifying the mixture to provide a plurality of droplets, wherein each droplet in the plurality comprises a plurality of the sacrificial particles; and
adding a remainder of the total amount of gelation agent to the emulsified mixture, forming organogel particles from each droplet; and
optionally, drying the organogel particles.

In some embodiments, the composite particles comprise a central region extending from a center of the composite particle outward toward the exterior surface region, wherein the central region comprises sacrificial particles.

In some embodiments, the exterior surface region, including the exterior surface, comprises sacrificial particles.

In some embodiments, the sacrificial particles comprise sodium chloride, zinc, polymethylmethacrylate (PMMA), or a polyamic acid (PAA). In some embodiments, the sacrificial particles comprise PMMA, polyvinylpyrrolidone (PVP), polyvinyl acetate PVAc), polyvinyl alcohol (PVA), polyacrylonitrile (PAN), polypropylene oxide (PEO), polypropylene oxide (PPO), polyethyleneimine (PEI), polyurethane, poly(3,4-ethylenedioxythiophene, PEDOT), polyvinylbutyral, polyethylene oxide copolymer, polypropylene oxide copolymer, polycarbonate (PC), polyvinylchloride (PVC), polycaprolactone, polyvinylidene fluoride, polystyrene, Polytetrafluoroethylene (PTFE), or surface modified version of the aforementioned polymers to modified their surface functionality.

In some embodiments, the method further comprises suspending functional particles in the solution, suspension, mixture, or a combination thereof.

In some embodiments, the composite particles comprise a central region extending from a center of the composite particle outward toward the exterior surface region, wherein the central region comprises sacrificial particles and functional particles.

In some embodiments, the exterior surface region, including the exterior surface, comprises functional particles.

In some embodiments, the functional particles are electrochemically active.

In some embodiments, the functional particles comprise silicon.

In some embodiments, the functional particles comprise a sacrificial coating.

In some embodiments, the sacrificial coating comprises PMMA.

In some embodiments, the immiscible liquid is mineral spirits or a silicone oil.

In some embodiments, the droplets isolate the sacrificial particles from the gelation agent, thereby minimizing the reaction therebetween.

In some embodiments, the method further comprises adding a portion of the gelation agent to the solution of one or more matrix material precursors prior to suspending the sacrificial particles in the solution, after suspending the sacrificial particles in the solution but before combining the suspension with the immiscible liquid, or both before and after suspending the sacrificial particles in the solution. In some embodiments, the method further comprises adding a portion of the gelation agent to the solution of one or more matrix material precursors prior to suspending the sacrificial particles in the solution. In some embodiments, the method further comprises adding a portion of the gelation agent to the solution of one or more matrix material precursors after suspending the sacrificial particles in the solution but before combining the suspension with the immiscible liquid.

In some embodiments, the portion is about 10% to about 50% of a total amount of gelation agent.

In some embodiments, the gelation agent increases the viscosity of the suspension, thereby enhancing dispersion of the sacrificial particles in the suspension.

In some embodiments, the gelation agent creates a viscosity gradient within the droplets, and wherein the viscosity gradient forces sacrificial particles toward a center of the droplets, such that the exterior surface region of the composite particles has a deficit of sacrificial particles relative to the central region.

In some embodiments, the exterior surface region contains a greatest percentage by volume of the matrix material.

In some embodiments, the organogel comprises a polyimide.

In some embodiments, the matrix material precursors comprise a polyamic acid.

In some embodiments, the gelation agent is acetic anhydride.

In some embodiments, the organogel comprises a polyamic acid.

In some embodiments, the matrix material precursors comprise a salt of a polyamic acid.

In some embodiments, the gelation agent is acetic acid.

In some embodiments, the method further comprises calcining the organogel particles under an inert atmosphere at a temperature of at least about 650° C.

In some embodiments, the calcining:
isomorphically converts substantially all of the organogel to carbon; and
substantially removes the sacrificial particles, forming shaped pores.

In some embodiments, the functional particles comprise a sacrificial coating, and wherein the calcining substantially removes the sacrificial coating, forming void spaces around the functional particles.

In some embodiments, the composite particles are essentially free of sacrificial particle- or sacrificial coating-related residue.

In another aspect is provided a method of preparing composite particles comprising a matrix material and a plurality of sacrificial particles disposed within the matrix material, and wherein the composite particles comprise an exterior surface region, the method comprising:
providing a solution of one or more matrix material precursors in a solvent;
suspending sacrificial particles in the solution to form a suspension;
adding a gelation agent to the suspension, initiating formation of an organogel;
combining the suspension with an immiscible liquid to form a mixture;
emulsifying the mixture to provide a plurality of droplets and forming organogel particles from each droplet, wherein each droplet in the plurality comprises a plurality of the sacrificial particles; and
optionally, drying the organogel particles.

In some embodiments, the composite particles comprise a central region extending from a center of the composite particle outward toward the exterior surface region, wherein the central region comprises sacrificial particles.

In some embodiments, the exterior surface region, including the exterior surface, comprises sacrificial particles.

In some embodiments, the sacrificial particles comprise sodium chloride, zinc, polymethylmethacrylate (PMMA), or a polyamic acid (PAA) polyvinylpyrrolidone (PVP), polyvinyl acetate PVAc), polyvinyl alcohol (PVA), polyacrylonitrile (PAN), polypropylene oxide (PEO), polypropylene oxide (PPO), polyethyleneimine (PEI), polyurethane, poly(3,4-ethylenedioxythiophene, PEDOT), polyvinylbutyral, polyethylene oxide copolymer, polypropylene oxide copolymer, polycarbonate (PC), polyvinylchloride (PVC), polycaprolactone, polyvinylidene fluoride, polystyrene, Polytetrafluoroethylene (PTFE), or surface modified version of the aforementioned polymers to modified their surface functionality. In some embodiments, the sacrificial particles comprise PMMA.

In some embodiments, the method further comprises suspending functional particles in the solution or suspension.

In some embodiments, the composite particles comprise a central region extending from a center of the composite particle outward toward the exterior surface region, wherein the central region comprises sacrificial particles and functional particles.

In some embodiments, the exterior surface region, including the exterior surface, comprises functional particles.

In some embodiments, the functional particles are electrochemically active.

In some embodiments, the functional particles comprise silicon.

In some embodiments, the functional particles comprise a sacrificial coating.

In some embodiments, the sacrificial coating comprises PMMA.

In some embodiments, the immiscible liquid is mineral spirits or a silicone oil.

In some embodiments, the droplets isolate the sacrificial particles from the gelation agent, thereby minimizing the reaction therebetween.

In some embodiments, the gelation agent increases the viscosity of the suspension, thereby enhancing dispersion of the sacrificial particles in the suspension.

In some embodiments, the gelation agent creates a viscosity gradient within the droplets, and wherein the viscosity gradient forces sacrificial particles toward a center of the droplets, such that the exterior surface region of the composite particles has a deficit of sacrificial particles relative to the central region.

In some embodiments, the exterior surface region contains a greatest percentage by volume of the matrix material.

In some embodiments, the organogel comprises a polyimide.

In some embodiments, the matrix material precursors comprise a polyamic acid.

In some embodiments, the gelation agent is acetic anhydride.

In some embodiments, the organogel comprises a polyamic acid.

In some embodiments, the matrix material precursors comprise a salt of a polyamic acid.

In some embodiments, the gelation agent is acetic acid.

In some embodiments, the method further comprises calcining the organogel particles under an inert atmosphere at a temperature of at least about 650° C.

In some embodiments, the calcining:
isomorphically converts substantially all of the organogel to carbon; and
substantially removes the sacrificial particles, forming shaped pores.

In some embodiments, the functional particles comprise a sacrificial coating, and wherein the calcining substantially removes the sacrificial coating, forming void spaces around the functional particles.

In some embodiments, the composite particles are essentially free of sacrificial particle- or sacrificial coating-related residue.

In another aspect is provided a method of preparing composite particles comprising a matrix material and a plurality of functional particles disposed within the matrix material, and wherein the composite particles comprise an exterior surface region, the method comprising:
providing a solution of one or more matrix material precursors in a solvent;
suspending functional particles in the solution to form a suspension;
adding a gelation agent to the suspension, initiating formation of an organogel;
combining the suspension with an immiscible liquid to form a mixture;
emulsifying the mixture to provide a plurality of droplets, wherein each droplet in the plurality comprises a plurality of the functional particles; and
optionally, drying the organogel particles,
wherein the functional particles are electrochemically active.

In some embodiments, the functional particles comprise silicon, germanium, tin, or a combination thereof.

In some embodiments, the immiscible liquid is mineral spirits or a silicone oil.

In some embodiments, the organogel comprises a polyamic acid, a polyimide, or a combination thereof.

In some embodiments, the gelation agent is acetic acid.

In some embodiments, the composite particles comprise a central region extending from a center of the composite particle outward toward the exterior surface region, wherein the exterior surface region, including the exterior surface, comprises functional particles, and wherein the central region comprises fewer functional particles than the exterior surface region.

In some embodiments, the gelation agent is acetic anhydride.

In some embodiments, the composite particles comprise a central region extending from a center of the composite particle outward toward the exterior surface region, wherein the central region comprises more functional particles than the exterior surface region.

In some embodiments, the gelation agent creates a viscosity gradient within the droplets, and wherein the viscosity gradient forces functional particles toward a center of the droplets, such that the exterior surface region of the composite particles has a deficit of functional particles relative to the central region.

In some embodiments, the method further comprises calcining the organogel particles under an inert atmosphere at a temperature of at least about 650° C. In some embodiments, the calcining isomorphically converts substantially all of the organogel to carbon.

In a further aspect is provide a method of preparing composite particles comprising a matrix material and a plurality of functional particles disposed within the matrix material, and wherein the composite particles comprise an exterior surface region, the method comprising:
providing a solution of one or more matrix material precursors in a solvent;
optionally, adding a portion of a total amount of a gelation agent to the solution, initiating formation of an organogel;
suspending functional particles in the solution to form a suspension;
optionally, adding a portion of the total amount of the gelation agent to the solution, initiating or continuing formation of an organogel;
combining the suspension with an immiscible liquid to form a mixture;
emulsifying the mixture to provide a plurality of droplets, wherein each droplet in the plurality comprises a plurality of the functional particles;
adding a portion of the total amount of the gelation agent to the solution, initiating or continuing formation of an organogel; and
optionally, drying the organogel particles.

In some embodiments, the functional particles comprise silicon, germanium, tin, or a combination thereof.

In some embodiments, the immiscible liquid is mineral spirits or a silicone oil.

In some embodiments, the organogel comprises a polyamic acid, a polyimide, or a combination thereof.

In some embodiments, the gelation agent is acetic acid.

In some embodiments, the composite particles comprise a central region extending from a center of the composite particle outward toward the exterior surface region, wherein the exterior surface region, including the exterior surface, comprises functional particles, and wherein the central region comprises fewer functional particles than the exterior surface region.

In some embodiments, the gelation agent is acetic anhydride.

In some embodiments, the composite particles comprise a central region extending from a center of the composite particle outward toward the exterior surface region, wherein the central region comprises more functional particles than the exterior surface region.

In some embodiments, the gelation agent creates a viscosity gradient within the droplets, and wherein the viscosity gradient forces functional particles toward a center of the droplets, such that the exterior surface region of the composite particles has a deficit of functional particles relative to the central region.

In some embodiments, the method further comprises calcining the organogel particles under an inert atmosphere at a temperature of at least about 650° C. In some embodiments, the calcining isomorphically converts substantially all of the organogel to carbon.

In a still further aspect is provided a method of preparing composite particles comprising a matrix material and a plurality of functional particles disposed within the matrix material, and wherein the composite particles comprise an exterior surface region, the method comprising:
providing a solution of one or more matrix material precursors in a solvent;
suspending functional particles in the solution to form a suspension;
adding a first gelation agent to the solution, initiating formation of an organogel; combining the suspension with an immiscible liquid to form a mixture;
emulsifying the mixture to provide a plurality of droplets, wherein each droplet in the plurality comprises a plurality of the functional particles;
adding a second gelation agent to the solution, continuing formation of the organogel; and
optionally, drying the organogel particles.

In some embodiments, the functional particles are electrochemically active.

In some embodiments, the functional particles comprise silicon, germanium, tin, or a combination thereof.

In some embodiments, the immiscible liquid is mineral spirits or a silicone oil.

In some embodiments, the organogel comprises a polyamic acid, a polyimide, or a combination thereof.

In some embodiments, the first gelation agent is acetic anhydride and the second gelation agent is acetic acid.

In some embodiments, the composite particles comprise a central region extending from a center of the composite particle outward toward the exterior surface region, wherein the central region comprises more functional particles than the exterior surface region.

In some embodiments, the first gelation agent creates a viscosity gradient within the droplets, and wherein the viscosity gradient forces functional particles toward a center of the droplets, such that the exterior surface region of the composite particles has a deficit of functional particles relative to the central region.

In some embodiments, the method further comprises calcining the organogel particles under an inert atmosphere at a temperature of at least about 650° C.

In some embodiments, the calcining isomorphically converts substantially all of the organogel to carbon.

In a further aspect is provided a method of preparing composite particles comprising a matrix material and a plurality of functional particles disposed within the matrix material, and wherein the composite particles comprise an exterior surface region, the method comprising:
providing a solution of one or more matrix material precursors in a solvent;
suspending functional particles in the solution to form a suspension;
combining the suspension with an immiscible liquid to form a mixture;
emulsifying the mixture to provide a plurality of droplets, wherein each droplet in the plurality comprises a plurality of the functional particles;
adding a first gelation agent to the solution, initiating formation of an organogel;
adding a second gelation agent to the solution, continuing formation of the organogel; and
optionally, drying the organogel particles.

In some embodiments, the functional particles are electrochemically active.

In some embodiments, the functional particles comprise silicon, germanium, tin, or a combination thereof.

In some embodiments, the immiscible liquid is mineral spirits or a silicone oil.

In some embodiments, the organogel comprises a polyamic acid, a polyimide, or a combination thereof.

In some embodiments, the first gelation agent is acetic anhydride and the second gelation agent is acetic acid.

In some embodiments, the composite particles comprise a central region extending from a center of the composite particle outward toward the exterior surface region, wherein the central region comprises more functional particles than the exterior surface region.

In some embodiments, the first gelation agent creates a viscosity gradient within the droplets, and wherein the viscosity gradient forces functional particles toward a center of the droplets, such that the exterior surface region of the composite particles has a deficit of functional particles relative to the central region.

In some embodiments, the method further comprises calcining the organogel particles under an inert atmosphere at a temperature of at least about 650° C.

In some embodiments, the calcining isomorphically converts substantially all of the organogel to carbon.

The disclosure includes, without limitations, the following Embodiments.

Embodiment 1. A composite particle comprising:
a matrix material having an innate matrix porosity comprising matrix pores; and
a plurality of additive particles disposed within the matrix material, wherein an exterior surface region of the composite particle contains a greatest percentage by volume of the matrix material.

Embodiment 2. The composite particle of embodiment 1, comprising a central region extending from a center of the composite particle outward toward the exterior surface region, wherein the central region comprises additive particles.

Embodiment 3. The composite particle of embodiment 1 or 2, wherein the exterior surface region, including the exterior surface, comprises additive particles.

Embodiment 4. The composite particle of any one of embodiments 1-3, wherein the additive particles comprise functional particles and sacrificial particles.

Embodiment 5. The composite particle of embodiment 4, wherein the matrix material comprises shaped pores formed by the thermal decomposition of at least a portion of the sacrificial particles.

Embodiment 6. The composite particle of embodiment 5, wherein an amount of the shaped pores present is determined by an amount of the sacrificial particles present in the matrix material prior to the thermal decomposition thereof.

Embodiment 7. The composite particle of embodiment 5 or 6, wherein the shaped pores have a diameter from about 0.1 to about 1 times the diameter of the matrix pores.

Embodiment 8. The composite particle of embodiment 5 or 6, wherein the shaped pores have a diameter from about 1 to about 50,000 times larger than the diameter of the matrix pores.

Embodiment 9. The composite particle of any one of embodiments 5-7, wherein the shaped pores have a diameter in a range from about 0.05 μm to about 15 μm.

Embodiment 10. The composite particle of any one of embodiments 5-9, wherein the shaped pores are spherical pores or distorted spherical pores.

Embodiment 11. The composite particle of embodiment 10, wherein the shaped pores are connected to the matrix pores.

Embodiment 12. The composite material of any one of embodiments 5-11, wherein at least a portion of the functional particles are positioned adjacent to the shaped pores.

Embodiment 13. The composite particle of embodiment 13, wherein the functional particles each have a volume, the shaped pores each have a volume, and the matrix pores each have a volume, and wherein the volume of each functional particle is less than the volume of a shaped pore and greater than the volume of a matrix pore.

Embodiment 14. The composite particle of any one of embodiments 4-13, wherein the functional particles are electrochemically active.

Embodiment 15. The composite particle of embodiment 14, wherein the functional particles comprise silicon, germanium, tin, or combinations thereof.

Embodiment 16. The composite particle of any one of embodiments 4-15, wherein the functional particles comprise a sacrificial coating.

Embodiment 17. The composite particle of any one of embodiments 4-15, comprising void space surrounding the functional particles, the void space formed by the thermal decomposition of a sacrificial coating.

Embodiment 18. The composite particle of any one of embodiments 1-17, wherein the exterior surface region has a thickness in a range from about 0.1% to about 25% of the diameter of the composite particle.

Embodiment 19. The composite particle of any one of embodiments 1-18, wherein a thickness of the exterior surface region varies along an exterior surface of the composite particle.

Embodiment 20. The composite particle of any one of embodiments 4-19, wherein the composite particle has a total volume of the shaped pores and a total volume of the functional particles, and wherein the total volume of the functional particles is less than the total volume of the shaped pores.

Embodiment 21. The composite particle of embodiment 20, wherein the total volume of the shaped pores is about 0.1 to about 10 times the total volume of the functional particles.

Embodiment 22. The composite particle of any one of embodiments 1-21, wherein the composite particle comprises surface depressions projecting from an outer surface of the particle into the exterior surface region, and wherein said surface depressions comprise one or more functional particles.

Embodiment 23. The composite particle of any one of embodiments 1-22, wherein the matrix material comprises carbon.

Embodiment 24. The composite particle of embodiment 23, wherein the matrix material is formed by the thermal decomposition of an organogel material.

Embodiment 25. A composite particle comprising:
a matrix material having an innate matrix porosity comprising matrix pores; and
a plurality of functional additive particles disposed within the matrix material and a plurality of sacrificial additive particles disposed within the matrix material;
a plurality of voids disposed within the matrix material, said voids formed by the thermal decomposition of sacrificial additive particles; or
a combination of a plurality of functional additive particles disposed within the matrix material and a plurality of voids disposed within the matrix material, said voids formed by the thermal decomposition of sacrificial additive particles,
wherein an exterior surface region of the composite particle contains a greatest percentage by volume of the matrix material.

Embodiment 26. The composite particle of embodiment 25, comprising an exterior surface region and a central region, the central region extending from a center of the composite particle outward toward the exterior surface region, wherein the central region comprises the plurality of functional additive particles and the plurality of sacrificial additive particles, the plurality of voids, or the combination of the plurality of functional additive particles and the plurality of voids.

Embodiment 27. The composite particle of embodiment 25, wherein the exterior surface region, including an exterior surface, comprises additive particles.

Embodiment 28. The composite particle of any one of embodiments 25-27, wherein an amount of the voids present is determined by an amount of the sacrificial particles present in the matrix material prior to the thermal decomposition thereof.

Embodiment 29. The composite particle of any one of embodiments 25-28, wherein the voids are shaped pores.

Embodiment 30. The composite particle of embodiment 29, wherein the shaped pores have a diameter from about 0.1 to about 1 times the diameter of the matrix pores.

Embodiment 31. The composite particle of embodiment 29, wherein the shaped pores have a diameter from about 1 to about 50,000 times larger than the diameter of the matrix pores.

Embodiment 32. The composite particle of embodiments 29, wherein the shaped pores have a diameter in a range from about 0.05 μm to about 15 μm.

Embodiment 33. The composite particle of any one of embodiments 29-32, wherein the shaped pores are spherical pores or distorted spherical pores.

Embodiment 34. The composite particle of any one of embodiments 29-33, wherein the shaped pores are connected to the matrix pores.

Embodiment 35. The composite material of any one of embodiments 29-34, wherein at least a portion of the functional particles are positioned adjacent to the shaped pores.

Embodiment 36. The composite particle of embodiment 35, wherein the functional particles each have a volume, the shaped pores each have a volume, and the matrix pores each have a volume, and wherein the volume of each functional particle is less than the volume of a shaped pore and greater than the volume of a matrix pore.

Embodiment 37. The composite particle of any one of embodiments 25-36, wherein the functional particles are electrochemically active.

Embodiment 38. The composite particle of embodiment 37, wherein the functional particles comprise silicon, germanium, tin, or combinations thereof.

Embodiment 39. The composite particle of any one of embodiments 25-38, wherein the functional particles comprise a sacrificial coating.

Embodiment 40. The composite particle of any one of embodiments 25-38, comprising void space surrounding the functional particles formed by the thermal decomposition of a sacrificial coating.

Embodiment 41. The composite particle of any one of embodiments 25-40, wherein the exterior surface region has a thickness in a range from about 0.1% to about 25% of the diameter of the composite particle.

Embodiment 42. The composite particle of any one of embodiments 25-41, wherein a thickness of the exterior surface region varies along an exterior surface of the composite particle.

Embodiment 43. The composite particle of any one of embodiments 29-42, wherein the composite particle has a total volume of the shaped pores and a total volume of the functional particles, and wherein the total volume of the functional particles is less than the total volume of the shaped pores.

Embodiment 44. The composite particle of embodiment 43, wherein the total volume of the shaped pores is about 0.1 to about 10 times the total volume of the functional particles.

Embodiment 45. The composite particle of any one of embodiments 25-44, wherein the composite particle comprises surface depressions projecting from an outer surface of the particle into the exterior surface region, and wherein said surface depressions comprise one or more functional particles.

Embodiment 46. The composite particle of any one of embodiments 25-45, wherein the matrix material comprises carbon.

Embodiment 47. The composite particle of embodiment 46, wherein the matrix material is formed by the thermal decomposition of an organogel material.

Embodiment 48. A composite particle comprising:
a matrix material extending from a center of the composite particle to an exterior surface of the composite particle and forming a three-dimensional network, the matrix material having an innate matrix porosity comprising matrix pores;
a plurality of additive particles dispersed heterogeneously within the matrix material; and
an inner region extending outward from the center to an outer region, said outer region extending outward from the inner region to the exterior surface,
wherein said inner and outer regions are defined by a population density of additive particles, the inner region having a higher population density of additive particles relative to the outer region.

Embodiment 49. The composite particle of embodiment 48, wherein the exterior surface region, including the exterior surface, comprises additive particles.

Embodiment 50. The composite particle of embodiment 48 or 49, wherein the additive particles comprise functional particles and sacrificial particles.

Embodiment 51. The composite particle of embodiment 50, wherein the matrix material comprises shaped pores formed by the thermal decomposition of at least a portion of the sacrificial particles.

Embodiment 52. The composite particle of embodiment 51, wherein an amount of the shaped pores present is determined by an amount of the sacrificial particles present in the matrix material prior to the thermal decomposition thereof.

Embodiment 53. The composite particle of embodiment 51 or 52, wherein the shaped pores have a diameter from about 0.1 to about 1 times the diameter of the matrix pores.

Embodiment 54. The composite particle of embodiment 51 or 52, wherein the shaped pores have a diameter from about 1 to about 50,000 times larger than the diameter of the matrix pores.

Embodiment 55. The composite particle of any one of embodiments 51-53, wherein the shaped pores have a diameter in a range from about 0.05 μm to about 15 μm.

Embodiment 56. The composite particle of any one of embodiments 51-55, wherein the shaped pores are spherical pores or distorted spherical pores.

Embodiment 57. The composite particle of embodiment 56, wherein the shaped pores are connected to the matrix pores.

Embodiment 58. The composite material of any one of embodiments 51-57, wherein at least a portion of the functional particles are positioned adjacent to the shaped pores.

Embodiment 59. The composite particle of embodiment 58, wherein the functional particles each have a volume, the shaped pores each have a volume, and the matrix pores each have a volume, and wherein the volume of each functional particle is less than the volume of a shaped pore and greater than the volume of a matrix pore.

Embodiment 60. The composite particle of any one of embodiments 50-59, wherein the functional particles are electrochemically active.

Embodiment 61. The composite particle of embodiment 60, wherein the functional particles comprise silicon, germanium, tin, or combinations thereof.

Embodiment 62. The composite particle of any one of embodiments 50-61, wherein the functional particles comprise a sacrificial coating.

Embodiment 63. The composite particle of any one of embodiments 50-61, comprising void space surrounding the functional particles, the void space formed by the thermal decomposition of a sacrificial coating.

Embodiment 64. The composite particle of any one of embodiments 48-63, wherein the exterior surface region has a thickness in a range from about 0.1% to about 25% of the diameter of the composite particle.

Embodiment 65. The composite particle of any one of embodiments 48-64, wherein a thickness of the exterior surface region varies along an exterior surface of the composite particle.

Embodiment 663. The composite particle of any one of embodiments 51-65, wherein the composite particle has a total volume of the shaped pores and a total volume of the functional particles, and wherein the total volume of the functional particles is less than the total volume of the shaped pores.

Embodiment 67. The composite particle of embodiment 66, wherein the total volume of the shaped pores is about 0.1 to about 10 times the total volume of the functional particles.

Embodiment 68. The composite particle of any one of embodiments 50-67, wherein the composite particle comprises surface depressions projecting from an outer surface of the particle into the exterior surface region, and wherein said surface depressions comprise one or more functional particles.

Embodiment 69. The composite particle of any one of embodiments 48-68, wherein the matrix material comprises carbon.

Embodiment 70. The composite particle of embodiment 69, wherein the matrix material is formed by the thermal decomposition of an organogel material.

Embodiment 71. A composite particle comprising:
a matrix material having an innate matrix porosity comprising matrix pores; and
a plurality of functional additive particles disposed within the matrix material and a plurality of sacrificial additive particles disposed within the matrix material;
a plurality of voids disposed within the matrix material, said voids formed by the thermal decomposition of sacrificial additive particles; or
a combination of a plurality of functional additive particles disposed within the matrix material and a plurality of voids disposed within the matrix material, said voids formed by the thermal decomposition of sacrificial additive particles.

Embodiment 72. The composite particle of embodiment 71, wherein an amount of the voids present is determined by an amount of the sacrificial particles present in the matrix material prior to the thermal decomposition thereof.

Embodiment 73. The composite particle of embodiment 71 or 72, wherein the voids are shaped pores.

Embodiment 74. The composite particle of embodiment 73, wherein the shaped pores have a diameter from about 0.1 to about 1 times the diameter of the matrix pores.

Embodiment 75. The composite particle of embodiment 73, wherein the shaped pores have a diameter from about 1 to about 50,000 times larger than the diameter of the matrix pores.

Embodiment 76. The composite particle of embodiments 73, wherein the shaped pores have a diameter in a range from about 0.05 μm to about 15 μm.

Embodiment 77. The composite particle of any one of embodiments 73-76, wherein the shaped pores are spherical pores or distorted spherical pores.

Embodiment 78. The composite particle of any one of embodiments 73-77, wherein the shaped pores are connected to the matrix pores.

Embodiment 79. The composite material of any one of embodiments 73-78, wherein at least a portion of the functional particles are positioned adjacent to the shaped pores.

Embodiment 80. The composite particle of embodiment 79, wherein the functional particles each have a volume, the shaped pores each have a volume, and the matrix pores each have a volume, and wherein the volume of each functional particle is less than the volume of a shaped pore and greater than the volume of a matrix pore.

Embodiment 81. The composite particle of any one of embodiments 73-80, wherein the functional particles are electrochemically active.

Embodiment 82. The composite particle of embodiment 81, wherein the functional particles comprise silicon.

Embodiment 83. The composite particle of any one of embodiments 71-82, wherein the functional particles comprise a sacrificial coating.

Embodiment 84. The composite particle of any one of embodiments 71-82, comprising void space surrounding the functional particles formed by the thermal decomposition of a sacrificial coating.

Embodiment 85. The composite particle of any one of embodiments 73-84, wherein the composite particle has a total volume of the shaped pores and a total volume of the functional particles, and wherein the total volume of the functional particles is less than the total volume of the shaped pores.

Embodiment 86. The composite particle of embodiment 85, wherein the total volume of the shaped pores is about 0.1 to about 10 times the total volume of the functional particles.

Embodiment 87. The composite particle of any one of embodiments 71-86, wherein the composite particle comprises surface depressions projecting inward from an outer surface of the particle, and wherein said surface depressions comprise one or more functional particles.

Embodiment 88. The composite particle of any one of embodiments 71-87, wherein the matrix material comprises carbon.

Embodiment 89. The composite particle of embodiment 88, wherein the matrix material is formed by the thermal decomposition of an organogel material.

Embodiment 90. An electrode for a battery comprising the composite particle of any one of embodiments 1-89.

Embodiment 91. A battery cell, battery module, or battery pack comprising the composite particle of any one of embodiments 1-89.

Embodiment 92. An electric vehicle, an energy storage system, or an electronic device comprising the electrode of embodiment 90.

Embodiment 93. A method of preparing composite particles comprising a matrix material and a plurality of sacrificial particles disposed within the matrix material, and wherein the composite particles comprise an exterior surface region, the method comprising:
providing a solution of one or more matrix material precursors in a solvent;
suspending sacrificial particles in the solution to form a suspension;
combining the suspension with an immiscible liquid to form a mixture;
emulsifying the mixture to provide a plurality of droplets, wherein each droplet in the plurality comprises a plurality of the sacrificial particles;
adding a gelation agent to the emulsified mixture, forming organogel particles from each droplet; and
optionally, drying the organogel particles.

Embodiment 94. A method of preparing composite particles comprising a matrix material and a plurality of sacrificial particles disposed within the matrix material, and wherein the composite particles comprise an exterior surface region, the method comprising:
providing a solution of one or more matrix material precursors in a solvent;
optionally, suspending functional particles in the solution;
adding a portion of a total amount of a gelation agent to the solution, initiating formation of an organogel;
suspending sacrificial particles in the solution to form a suspension;
combining the suspension with an immiscible liquid to form a mixture;
emulsifying the mixture to provide a plurality of droplets, wherein each droplet in the plurality comprises a plurality of the sacrificial particles; and
adding a remainder of the total amount of gelation agent to the emulsified mixture, forming organogel particles from each droplet; and
optionally, drying the organogel particles.

Embodiment 95. The method of embodiment 93 or 94, wherein the composite particles comprise a central region extending from a center of the composite particle outward toward the exterior surface region, wherein the central region comprises sacrificial particles.

Embodiment 96. The method of any one of embodiments 93-95, wherein the exterior surface region, including the exterior surface, comprises sacrificial particles.

Embodiment 97. The method of any one of embodiments 93-96, wherein the sacrificial particles comprise sodium chloride, zinc, polymethylmethacrylate (PMMA), or a polyamic acid (PAA).

Embodiment 98. The method of any one of embodiments 93-97, wherein the sacrificial particles comprise PMMA.

Embodiment 99. The method of any one of embodiments 93 or 95-98, further comprising suspending functional particles in the solution, suspension, mixture, or a combination thereof.

Embodiment 100. The method of embodiment 99, wherein the composite particles comprise a central region extending from a center of the composite particle outward toward the exterior surface region, wherein the central region comprises sacrificial particles and functional particles.

Embodiment 101. The method of embodiment 99 or 100, wherein the exterior surface region, including the exterior surface, comprises functional particles.

Embodiment 102. The method of any one of embodiments 94 or 98-100, wherein the functional particles are electrochemically active.

Embodiment 103. The method of embodiment 102, wherein the functional particles comprise silicon, germanium, tin, or a combination thereof.

Embodiment 104. The method of any one of embodiments 94 or 98-102, wherein the functional particles comprise a sacrificial coating.

Embodiment 105. The method of embodiment 104, wherein the sacrificial coating comprises PMMA.

Embodiment 106. The method of any one of embodiments 93-105, wherein the immiscible liquid is mineral spirits or a silicone oil.

Embodiment 107. The method of any one of embodiments 93-106, wherein the droplets isolate the sacrificial particles from the gelation agent, thereby minimizing the reaction therebetween.

Embodiment 108. The method of any one of embodiments 93 or 95-107, further comprising adding a portion of the gelation agent to the solution of one or more matrix material precursors prior to suspending the sacrificial particles in the solution, after suspending the sacrificial particles in the solution but before combining the suspension with the immiscible liquid, or both before and after suspending the sacrificial particles in the solution.

Embodiment 109. The method of embodiment 94 or 108, wherein the portion of the gelation agent is about 10% to about 50% of a total amount of gelation agent.

Embodiment 110. The method of embodiment 108 or 109, wherein the gelation agent increases the viscosity of the suspension, thereby enhancing dispersion of the sacrificial particles in the suspension.

Embodiment 111. The method of any one of embodiments 108-110, wherein the gelation agent creates a viscosity gradient within the droplets, and wherein the viscosity gradient forces sacrificial particles toward a center of the droplets, such that the exterior surface region of the composite particles has a deficit of sacrificial particles relative to the central region.

Embodiment 112. The method of any one of embodiments 108-111, wherein the exterior surface region contains a greatest percentage by volume of the matrix material.

Embodiment 113. The method of any one of embodiments 93-112, wherein the organogel comprises a polyimide.

Embodiment 114. The method of embodiment 113, wherein the matrix material precursors comprise a polyamic acid.

Embodiment 115. The method of embodiment 113 or 114, wherein the gelation agent is acetic anhydride.

Embodiment 116. The method of any one of embodiments 93-107, wherein the organogel comprises a polyamic acid.

Embodiment 117. The method of embodiment 116, wherein the matrix material precursors comprise a salt of a polyamic acid.

Embodiment 118. The method of embodiment 116 or 117, wherein the gelation agent is acetic acid.

Embodiment 119. The method of any one of embodiments 93-118, further comprising calcining the organogel particles under an inert atmosphere at a temperature of at least about 650° C.

Embodiment 120. The method of embodiment 119, wherein the calcining:
isomorphically converts substantially all of the organogel to carbon; and
substantially removes the sacrificial particles, forming shaped pores.

Embodiment 121. The method of embodiment 119 or 120, wherein the functional particles comprise a sacrificial coating, and wherein the calcining substantially removes the sacrificial coating, forming void spaces around the functional particles.

Embodiment 122. The method of any one of embodiments 119 to 121, wherein the composite particles are essentially free of sacrificial particle- or sacrificial coating-related residue.

Embodiment 123. A method of preparing composite particles comprising a matrix material and a plurality of sacrificial particles disposed within the matrix material, and wherein the composite particles comprise an exterior surface region, the method comprising:
providing a solution of one or more matrix material precursors in a solvent;
suspending sacrificial particles in the solution to form a suspension;
adding a gelation agent to the suspension, initiating formation of an organogel;
combining the suspension with an immiscible liquid to form a mixture;
emulsifying the mixture to provide a plurality of droplets and forming organogel particles from each droplet, wherein each droplet in the plurality comprises a plurality of the sacrificial particles; and
optionally, drying the organogel particles.

Embodiment 124. The method of embodiment 123, wherein the composite particles comprise a central region extending from a center of the composite particle outward toward the exterior surface region, wherein the central region comprises sacrificial particles.

Embodiment 125. The method of embodiment 123 or 124, wherein the exterior surface region, including the exterior surface, comprises sacrificial particles.

Embodiment 126. The method of any one of embodiments 123-125, wherein the sacrificial particles comprise sodium chloride, zinc, polymethylmethacrylate (PMMA), or a polyamic acid (PAA).

Embodiment 127. The method of any one of embodiments 123-126, wherein the sacrificial particles comprise PMMA.

Embodiment 128. The method of any one of embodiments 123-127, further comprising suspending functional particles in the solution or suspension.

Embodiment 129. The method of embodiment 128, wherein the composite particles comprise a central region extending from a center of the composite particle outward toward the exterior surface region, wherein the central region comprises sacrificial particles and functional particles.

Embodiment 130. The method of embodiment 128 or 129, wherein the exterior surface region, including the exterior surface, comprises functional particles.

Embodiment 131. The method of any one of embodiments 128-130, wherein the functional particles are electrochemically active.

Embodiment 132. The method of embodiment 131, wherein the functional particles comprise silicon, germanium, tin, or a combination thereof.

Embodiment 133. The method of any one of embodiments 128-132, wherein the functional particles comprise a sacrificial coating.

Embodiment 134. The method of embodiment 133, wherein the sacrificial coating comprises PMMA.

Embodiment 135. The method of any one of embodiments 123-134, wherein the immiscible liquid is mineral spirits or a silicone oil.

Embodiment 136. The method of any one of embodiments 123-135, wherein the droplets isolate the sacrificial particles from the gelation agent, thereby minimizing the reaction therebetween.

Embodiment 137. The method of any one of embodiments 123-136, wherein the gelation agent increases the viscosity of the suspension, thereby enhancing dispersion of the sacrificial particles in the suspension.

Embodiment 138. The method of any one of embodiments 123-137, wherein the gelation agent creates a viscosity gradient within the droplets, and wherein the viscosity gradient forces sacrificial particles toward a center of the droplets, such that the exterior surface region of the composite particles has a deficit of sacrificial particles relative to the central region.

Embodiment 139. The method of any one of embodiments 123-138, wherein the exterior surface region contains a greatest percentage by volume of the matrix material.

Embodiment 140. The method of any one of embodiments 123-139, wherein the organogel comprises a polyimide.

Embodiment 141. The method of embodiment 140, wherein the matrix material precursors comprise a polyamic acid.

Embodiment 142. The method of embodiment 140 or 141, wherein the gelation agent is acetic anhydride.

Embodiment 143. The method of any one of embodiments 123-136, wherein the organogel comprises a polyamic acid.

Embodiment 144. The method of embodiment 143, wherein the matrix material precursors comprise a salt of a polyamic acid.

Embodiment 145. The method of embodiment 143 or 144, wherein the gelation agent is acetic acid.

Embodiment 146. The method of any one of embodiments 123-145, further comprising calcining the organogel particles under an inert atmosphere at a temperature of at least about 650° C.

Embodiment 147. The method of embodiment 146, wherein the calcining:
isomorphically converts substantially all of the organogel to carbon; and
substantially removes the sacrificial particles, forming shaped pores.

Embodiment 148. The method of embodiment 146 or 147, wherein the functional particles comprise a sacrificial coating, and wherein the calcining substantially removes the sacrificial coating, forming void spaces around the functional particles.

Embodiment 149. The method of any one of embodiments 146 to 148, wherein the composite particles are essentially free of sacrificial particle- or sacrificial coating-related residue.

Embodiment 150. A method of preparing composite particles comprising a matrix material and a plurality of functional particles disposed within the matrix material, and wherein the composite particles comprise an exterior surface region, the method comprising:
providing a solution of one or more matrix material precursors in a solvent;
suspending functional particles in the solution to form a suspension;
adding a gelation agent to the suspension, initiating formation of an organogel;
combining the suspension with an immiscible liquid to form a mixture;
emulsifying the mixture to provide a plurality of droplets, wherein each droplet in the plurality comprises a plurality of the functional particles; and
optionally, drying the organogel particles.

Embodiment 151. A method of preparing composite particles comprising a matrix material and a plurality of functional particles disposed within the matrix material, and wherein the composite particles comprise an exterior surface region, the method comprising:
providing a solution of one or more matrix material precursors in a solvent;
optionally, adding a portion of a total amount of a gelation agent to the solution, initiating formation of an organogel;
suspending functional particles in the solution to form a suspension;
optionally, adding a portion of the total amount of the gelation agent to the solution, initiating or continuing formation of an organogel;
combining the suspension with an immiscible liquid to form a mixture;
emulsifying the mixture to provide a plurality of droplets, wherein each droplet in the plurality comprises a plurality of the functional particles;
adding a portion of the total amount of the gelation agent to the solution, initiating or continuing formation of an organogel; and
optionally, drying the organogel particles.

Embodiment 152. The method of embodiment 150 or 151, wherein the functional particles are electrochemically active.

Embodiment 153. The method of embodiment 152, wherein the functional particles comprise silicon, germanium, tin, or a combination thereof.

Embodiment 154. The method of any one of embodiments 150-153, wherein the immiscible liquid is mineral spirits or a silicone oil.

Embodiment 155. The method of any one of embodiments 150-154, wherein the organogel comprises a polyamic acid, a polyimide, or a combination thereof.

Embodiment 156. The method of embodiment 155, wherein the gelation agent is acetic acid.

Embodiment 157. The method of embodiment 156, wherein the composite particles comprise a central region extending from a center of the composite particle outward toward the exterior surface region, wherein the exterior surface region, including the exterior surface, comprises functional particles, and wherein the central region comprises fewer functional particles than the exterior surface region.

Embodiment 158. The method of embodiment 155, wherein t the gelation agent is acetic anhydride.

Embodiment 159. The method of embodiment 158, wherein the composite particles comprise a central region extending from a center of the composite particle outward toward the exterior surface region, wherein the central region comprises more functional particles than the exterior surface region.

Embodiment 160. The method of embodiment 158 or 159, wherein the gelation agent creates a viscosity gradient within the droplets, and wherein the viscosity gradient forces functional particles toward a center of the droplets, such that the exterior surface region of the composite particles has a deficit of functional particles relative to the central region.

Embodiment 161. The method of any one of embodiments 150-160, further comprising calcining the organogel particles under an inert atmosphere at a temperature of at least about 650° C.

Embodiment 162. The method of embodiment 161, wherein the calcining isomorphically converts substantially all of the organogel to carbon.

Embodiment 163. A method of preparing composite particles comprising a matrix material and a plurality of functional particles disposed within the matrix material, and wherein the composite particles comprise an exterior surface region, the method comprising:
providing a solution of one or more matrix material precursors in a solvent;
suspending functional particles in the solution to form a suspension;
adding a first gelation agent to the solution, initiating formation of an organogel;
combining the suspension with an immiscible liquid to form a mixture;
emulsifying the mixture to provide a plurality of droplets, wherein each droplet in the plurality comprises a plurality of the functional particles;
adding a second gelation agent to the solution, continuing formation of the organogel; and
optionally, drying the organogel particles.

Embodiment 164. A method of preparing composite particles comprising a matrix material and a plurality of functional particles disposed within the matrix material, and wherein the composite particles comprise an exterior surface region, the method comprising:
providing a solution of one or more matrix material precursors in a solvent;
suspending functional particles in the solution to form a suspension;
combining the suspension with an immiscible liquid to form a mixture;
emulsifying the mixture to provide a plurality of droplets, wherein each droplet in the plurality comprises a plurality of the functional particles;
adding a first gelation agent to the solution, initiating formation of an organogel;
adding a second gelation agent to the solution, continuing formation of the organogel; and
optionally, drying the organogel particles.

Embodiment 165. The method of embodiment 163 or 164, wherein the functional particles are electrochemically active.

Embodiment 166. The method of embodiment 165, wherein the functional particles comprise silicon, germanium, tin, or a combination thereof.

Embodiment 167. The method of any one of embodiments 163-166, wherein the immiscible liquid is mineral spirits or a silicone oil.

Embodiment 168. The method of any one of embodiments 163-167, wherein the organogel comprises a polyamic acid, a polyimide, or a combination thereof.

Embodiment 169. The method of embodiment 168, wherein the first gelation agent is acetic anhydride and the second gelation agent is acetic acid.

Embodiment 170. The method of embodiment 169, wherein the composite particles comprise a central region extending from a center of the composite particle outward toward the exterior surface region, wherein the central region comprises more functional particles than the exterior surface region.

Embodiment 171. The method of embodiment 169 or 170, wherein the first gelation agent creates a viscosity gradient within the droplets, and wherein the viscosity gradient forces functional particles toward a center of the droplets, such that the exterior surface region of the composite particles has a deficit of functional particles relative to the central region.

Embodiment 172. The method of any one of embodiments 163-171, further comprising calcining the organogel particles under an inert atmosphere at a temperature of at least about 650° C.

Embodiment 173. The method of embodiment 172, wherein the calcining isomorphically converts substantially all of the organogel to carbon.

### BRIEF DESCRIPTION OF THE DRAWINGS

In order to provide an understanding of embodiments of the technology, reference is made to the appended drawings, which are not necessarily drawn to scale. The drawings are exemplary only and should not be construed as limiting the technology. The disclosure described herein is illustrated by way of example and not by way of limitation in the accompanying figures.

FIG. 1 is a schematic representation of a composite particle prior to calcining according to a non-limiting embodiment of the disclosure.

FIG. 2A is a schematic representation of a composite particle after calcining according to a non-limiting embodiment of the disclosure.

FIG. 2B is a schematic representation of another composite particle after calcining according to a non-limiting embodiment of the disclosure.

FIG. 2C is a schematic representation of another composite particle after calcining according to a non-limiting embodiment of the disclosure.

FIG. 2D is a schematic representation of another composite particle after calcining according to a non-limiting embodiment of the disclosure.

FIG. 3A is a schematic representation of a composite particle prior to calcining according to a non-limiting embodiment of the disclosure.

FIG. 3B is a schematic representation of a composite particle after calcining according to a non-limiting embodiment of the disclosure.

FIG. 3C is a schematic representation of another composite particle after calcining according to a non-limiting embodiment of the disclosure.

FIG. 3D is an enlarged schematic representation relative to FIG. 3C, showing irregularly shaped void spaces produced from agglomerated sacrificial particles following calcination.

FIG. 4A is a schematic representation of a composite particle after calcining according to a non-limiting embodiment of the disclosure.

FIG. 4B is a schematic representation of another composite particle after calcining according to a non-limiting embodiment of the disclosure.

FIG. 4C is a schematic representation of another composite particle after calcining according to a non-limiting embodiment of the disclosure.

FIG. 4D is a schematic representation of another composite particle after calcining according to a non-limiting embodiment of the disclosure.

FIG. 4E is a schematic representation of another composite particle after calcining according to a non-limiting embodiment of the disclosure.

FIG. 5 is a flow diagram illustrating a process for preparing composite particles according to a non-limiting embodiment of the disclosure.

FIG. 6A is a flow diagram illustrating another process for preparing composite particles according to a non-limiting embodiment of the disclosure.

FIG. 6B is a flow diagram illustrating another process for preparing composite particles according to a non-limiting embodiment of the disclosure.

FIG. 6C is a flow diagram illustrating another process for preparing composite particles according to a non-limiting embodiment of the disclosure.

FIG. 6D is a flow diagram illustrating another process for preparing composite particles according to a non-limiting embodiment of the disclosure.

FIG. 7A is a flow diagram illustrating a process for preparing composite particles according to a non-limiting embodiment of the disclosure.

FIG. 7B is a flow diagram illustrating a process for preparing composite particles according to a non-limiting embodiment of the disclosure.

FIG. 7C is a flow diagram illustrating a process for preparing composite particles according to a non-limiting embodiment of the disclosure.

FIG. 7D is a flow diagram illustrating a process for preparing composite particles according to a non-limiting embodiment of the disclosure.

FIG. 8 is a photomicrograph of a collection of carbon aerogel beads obtained according to a non-limiting embodiment of the disclosure.

FIG. 9 is a photomicrograph of a collection of carbon aerogel beads obtained according to a non-limiting embodiment of the disclosure.

FIG. 10 is a photomicrograph of a collection of carbon aerogel beads obtained according to a non-limiting embodiment of the disclosure.

FIG. 11 is a photomicrograph of a collection of carbon aerogel beads obtained according to a non-limiting embodiment of the disclosure.

FIG. 12 is a photomicrograph of a collection of carbon aerogel beads obtained according to a non-limiting embodiment of the disclosure.

FIG. 13 is a photomicrograph of a collection of carbon aerogel beads obtained according to a non-limiting embodiment of the disclosure.

### DETAILED DESCRIPTION

Before describing several example embodiments of the technology, it is to be understood that the technology is not limited to the details of construction or process steps set forth in the following description. The technology is capable of other embodiments and of being practiced or being carried out in various ways. The embodiments described herein are interchangeable, that is that features mentioned in the context of a particular aspect are not limited to that aspect but may be applied to and combined with each and every other aspect.

### Definitions

With respect to the terms used in this disclosure, the following definitions are provided. This application will use the following terms as defined below unless the context of the text in which the term appears requires a different meaning.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means±10% of the numerical. In an embodiment, the term “about” can include traditional rounding according to significant figures of the numerical value. In addition, the phrase “about ‘x’ to ‘y’” includes “about ‘x’ to about ‘y’”.

As used herein, the term “gelation” or “gel transition” refers to the formation of a wet gel from a polymer system, e.g., a polyimide or polyamic acid as described herein. At a point in the polymerization or dehydration reactions as described herein, which is defined as the “gel point,” the sol loses fluidity. Without intending to be bound to any particular theory, the gel point may be viewed as the point where the gelling solution exhibits resistance to flow. In the present context, gelation proceeds from an initial sol state, where the solution comprises primarily the amine salt of the polyamic acid, through a fluid colloidal dispersion state, until sufficient polyimide has formed to reach the gel point. Gelation may continue thereafter, producing a polyimide wet gel dispersion of increasing viscosity. The amount of time it takes for the polymer (i.e., polyamic acid and/or polyimide) in solution to transform into a gel in a form that can no longer flow is referred to as the “phenomenological gelation time.” Formally, gelation time is measured using rheology. At the gel point, the elastic property of the solid gel starts dominating over the viscous properties of the fluid sol. The formal gelation time is near the time at which the real and imaginary components of the complex modulus of the gelling sol cross. The two moduli are monitored as a function of time using a rheometer. Time starts counting from the moment the last component of the sol is added to the solution. See, for example, discussions of gelation in H. H. Winter “Can the Gel Point of a Cross-linking Polymer Be Detected by the G′-G″ Crossover?” Polym. Eng. Sci., 1987, 27, 1698-1702; S.-Y. Kim, D.-G. Choi and S.-M. Yang “Rheological analysis of the gelation behavior of tetraethylorthosilane/vinyltriethoxysilane hybrid solutions” Korean J. Chem. Eng., 2002, 19, 190-196; and M. Muthukumar “Screening effect on viscoelasticity near the gel point” Macromolecules, 1989, 22, 4656-4658.

Within the context of the present disclosure, the term “wet gel” refers to a gel in which the mobile interstitial phase within the network of interconnected pores is primarily comprised of a liquid phase such as a conventional solvent, liquefied gases such as liquid carbon dioxide, or a combination thereof. Aerogels typically require the initial production of a wet gel, followed by processing and extraction to replace the mobile interstitial liquid phase in the gel with air or another gas. Examples of wet gels include, but are not limited to: alcogels, hydrogels, ketogels, carbonogels, and any other wet gels known to those in the art.

Within the context of the present disclosure, the term “average particle size” is synonymous with D50, meaning half of the population of particles has a particle size above this point, and half below. Particle size may be measured by laser light scattering techniques or by microscopic techniques. D90 particle size distribution indicates that 90% of the particles (by number) have a Feret diameter below a certain size as measured by Scanning Electron Microscopy (SEM), Transmission Electron Microscopy (TEM), or laser scattering particle size distribution analyzer. D10 particle size distribution indicates that 10% of the particles (by number) have a Feret diameter below a certain size as measured by Scanning Electron Microscopy (SEM), Transmission Electron Microscopy (TEM), or laser scattering particle size distribution analyzer. Unless otherwise indicated, particle size distribution reported herein are as determined by laser scattering particle size distribution analyzer.

Within the context of the present disclosure, the term “electrochemically active species” refers to an additive that is capable of accepting and releasing ions within an energy storage device. Using LIBs as an example, an electrochemically active species within the anode accepts lithium ions during charge and releases lithium ions during discharge.

Within the context of the present disclosure, the term “pore volume” refers to the total volume of pores within a sample of porous material. Pore volume is specifically measured as the volume of void space within the porous material, where that void space may be measurable and/or may be accessible by another material, for example an electrochemically active species such as silicon particles. It is typically recorded as cubic centimeters per gram (cm³/g or cc/g). The pore volume of a porous material may be determined by methods known in the art, for example including, but not limited to, surface area and porosity analyzer by nitrogen adsorption and desorption from which pore volume can be calculated. Within the context of the present disclosure, measurements of pore volume are acquired according to this method, unless otherwise stated. In certain embodiments, aerogel materials or compositions of the present disclosure (without incorporation of electrochemically active species, e.g., silicon) have a relatively large pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other embodiments, aerogel materials or compositions of the present disclosure (with incorporation of electrochemically active species, e.g., silicon) have a pore volume of about 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values.

Within the context of the present disclosure, the term “porosity” when used with respect to the composite materials disclosed herein, refers to a volumetric ratio of pores that does not contain another material (e.g., an electrochemically active species such as silicon particles) bonded to the walls of the pores. Generally, porosity may be determined by methods known in the art, for example including, but not limited to, the ratio of the pore volume of the composite material to its bulk density. Within the context of the present disclosure, measurements of porosity are acquired according to this method, unless otherwise stated.

It should be noted that pore volume and porosity are different measures for the same property of the pore structure, namely the “empty space” within the pore structure. For example, when silicon is used as the electrochemically active species contained within the pores of the composite particle, pore volume and porosity refer to the space that is “empty”, namely the space not utilized by the silicon or the matrix material.

Within the context of the present disclosure, the term “BET surface area” has its usual meaning of referring to the Brunauer-Emmett-Teller method for determining surface area by N₂ adsorption measurements. The BET surface area, expressed in m²/g, is a measure of the total surface area of a porous material (e.g., a composite particle as described herein) per unit of mass. Unless otherwise stated, “surface area” refers to BET surface area. As an alternative to BET surface area, a geometric outer surface area of e.g., a polyimide or carbon bead may be calculated based on the diameter of the bead. Generally, such geometric outer surface areas for beads of the present disclosure are within a range from about 3 to about 700 μm².

Within the context of the present disclosure, the term “density” refers to a measurement of the mass per unit volume of an aerogel material or composition. The term “density” generally refers to the true density of an aerogel material, as well as the bulk density of an aerogel composition. Density is typically recorded as kg/m³ or g/cc. The density of an aerogel material or composition may be determined by methods known in the art, including, but not limited to: Standard Test Method for Dimensions and Density of Preformed Block and Board-Type Thermal Insulation (ASTM C303, ASTM International, West Conshohocken, Pa.); Standard Test Methods for Thickness and Density of Blanket or Batt Thermal Insulations (ASTM C167, ASTM International, West Conshohocken, Pa.); or Determination of the apparent density of preformed pipe insulation (ISO 18098, International Organization for Standardization, Switzerland). Within the context of the present disclosure, density measurements are acquired according to ASTM C167 standards, unless otherwise stated. Preferably, aerogel materials or compositions of the present disclosure have a density of about 1.50 g/cc or less, about 1.40 g/cc or less, about 1.30 g/cc or less, about 1.20 g/cc or less, about 1.10 g/cc or less, about 1.00 g/cc or less, about 0.90 g/cc or less, about 0.80 g/cc or less, about 0.70 g/cc or less, about 0.60 g/cc or less, about 0.50 g/cc or less, about 0.40 g/cc or less, about 0.30 g/cc or less, about 0.20 g/cc or less, about 0.10 g/cc or less, or in a range between any two of these values, for example between about 0.15 g/cc and 1.5 g/cc or more particularly 0.50 g/cc and 1.30 g/cc.

The term “alkyl” as used herein refers to a straight chain or branched, saturated hydrocarbon generally having from 1 to 20 carbon atoms. Representative alkyl groups include, but are not limited to, methyl, ethyl, n-propyl, n-butyl, n-pentyl, and n-hexyl; while branched alkyls include, but are not limited to, isopropyl, sec-butyl, isobutyl, tert-butyl, isopentyl, and neopentyl. An alkyl group can be unsubstituted or substituted.

The term “alkenyl” as used herein refers to hydrocarbons containing normal, secondary, or tertiary carbon atoms, generally having from 1 to 20 carbon atoms, with at least one site of unsaturation, i.e., a carbon-carbon double bond. Examples include, but are not limited to ethylene or vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, and the like. An alkenyl group can be unsubstituted or substituted.

The term “alkynyl” as used herein refers to a hydrocarbon containing normal, secondary, or tertiary carbon atoms, generally having from 1 to 20 carbon atoms, with at least one site of unsaturation, i.e., a carbon-carbon triple bond. Examples include but are not limited to acetylene and propargyl. An alkynyl group can be unsubstituted or substituted.

The term “aryl” as used herein refers to a carbocyclic aromatic group generally having from 6 to 20 carbon atoms. Examples of aryl groups include, but are not limited to, phenyl, naphthyl, and anthracenyl. An aryl group can be unsubstituted or substituted.

The term “cycloalkyl” as used herein refers to a saturated carbocyclic radical, which may be mono- or bicyclic. Cycloalkyl groups include a ring having 3 to 7 carbon atoms as a monocycle, or 7 to 12 carbon atoms as a bicycle. Examples of monocyclic cycloalkyl groups include cyclopropyl, cyclobutyl, cyclopentyl, cyclohexyl, cycloheptyl, and cyclooctyl. A cycloalkyl group can be unsubstituted or substituted.

The term “substituted” as used herein and as applied to any of the above alkyl, alkenyl, alkynyl, aryl, cycloalkyl, and the like, means that one or more hydrogen atoms are each independently replaced with a substituent. Typical substituents include, but are not limited to, —X, —R, —OH, —OR, —SH, —SR, NH₂, —NHR, —N(R)₂, —N⁺(R)₃, —CX₃, —CN, —OCN, —SCN, —NCO, —NCS, —NO, —NO₂, —N₃, —NC(═O)H, —NC(═O)R, —C(═O)H, —C(═O)R, —C(═O)NH₂, —C(═O)N(R)₂, —SO₃—, —SO₃H, —S(═O)₂R, —OS(═O)₂OR, —S(═O)₂NH₂, —S(═O)₂N(R)₂, —S(═O)R, —OP(═O)(OH)₂, —OP(═O)(OR)₂, —P(═O)(OR)₂, —PO₃, —PO₃H₂, —C(═O)X, —C(═S)R, —CO₂H, —CO₂R, —CO₂—, —C(═S)OR, —C(═O)SR, —C(═S)SR, —C(═O)NH₂, —C(═O)N(R)₂, —C(═S)NH₂, —C(═S)N(R)₂, —C(═NH) NH₂, and —C(═NR)N(R)₂; wherein each X is independently selected for each occasion from F, Cl, Br, and I; and each R is independently selected for each occasion from C₁-C₂₀ alkyl and C₆-C₂₀ aryl. Wherever a group is described as “optionally substituted,” that group can be substituted with one or more of the above substituents, independently for each occasion.

It is to be understood that certain radical naming conventions can include either a mono-radical or a di-radical, depending on the context. For example, where a substituent requires two points of attachment to the rest of the molecule, it is understood that the substituent is a di-radical. For example, a substituent identified as alkyl that requires two points of attachment includes di-radicals such as —CH₂—, —CH₂CH₂—, —CH₂CH(CH₃)CH₂—, and the like. Other radical naming conventions clearly indicate that the radical is a di-radical such as “alkylene,” “alkenylene,” “arylene,” and the like.

Wherever a substituent is depicted as a di-radical (i.e., has two points of attachment to the rest of the molecule), it is to be understood that the substituent can be attached in any directional configuration unless otherwise indicated.

### I. Composite Particle

In one aspect is provided a composite particle comprising a matrix material having an innate matrix porosity comprising matrix pores; and a plurality of additive particles disposed within the matrix material. Each of the features of the composite particle is further described herein below.

### Matrix Material

The composite particle comprises a matrix material having an innate matrix porosity comprising matrix pores. The matrix material is present throughout the entire particle in the form of an interconnected, three-dimensional network. The composite particle has an exterior surface and a center, and the matrix material extends outward from the center to the exterior surface, forming a framework.

In some embodiments, the matrix material may be described as an aerogel. As used herein, the term “aerogel” refers to a solid object, irrespective of shape or size, comprising a framework of interconnected solid structures, with a corresponding network of interconnected pores integrated within the framework, and containing gases such as air as a dispersed interstitial medium. As such, aerogels are open non-fluid colloidal or polymer networks that are expanded throughout their whole volume by a gas and are formed by the removal of all swelling agents from a corresponding wet gel without substantial volume reduction or network compaction. Aerogels are generally characterized by the following physical and structural properties (according to nitrogen porosimetry testing and helium pycnometry) attributable to aerogels: (a) an average pore diameter ranging from about 2 nm to about 100 nm; (b) a porosity of at least 60% or more, and (c) a surface area of about 100 m²/g or more, such as from about 100 to about 600 m²/g as measured by nitrogen sorption analysis. It can be understood that the inclusion of additives, such as a reinforcement material or an electrochemically active species, for example, silicon, may decrease porosity and the surface area of the resulting aerogel composite. Densification may also decrease porosity of the resulting aerogel composite. Aerogel materials of the present disclosure (e.g., polymer and carbon aerogels) include any aerogels which satisfy the defining elements set forth above. Aerogel materials of the present disclosure thus include any aerogels or other open-celled compounds which satisfy the defining elements set forth above, including compounds which can be otherwise categorized as xerogels, cryogels, ambigels, microporous materials, and the like.

In some embodiments, the matrix material may be described as a xerogel. As used herein, the term “xerogel” refers to a gel comprising an open, non-fluid colloidal or polymer networks that is formed by the removal of all swelling agents from a corresponding gel without any precautions taken to avoid substantial volume reduction or to retard compaction. In contrast to an aerogel, a xerogel generally comprises a compact structure. Xerogels suffer substantial volume reduction during ambient pressure drying, and have surface areas of 0-100 m²/g, such as from about 0 to about 20 m²/g as measured by nitrogen sorption analysis.

The matrix material may comprise or consist of various substances. In some embodiments, the matrix material comprises carbon. In some embodiments, the matrix material is carbon which is formed by the thermal decomposition of an organogel material. Suitable organogel materials, methods of preparing them, and conversion of organogel matrix materials to carbon matrix materials are each described further herein below.

Additive Particles and their Distribution

The composite particles as disclosed herein comprise a plurality of additive particles disposed within the matrix material. The distribution of the additive particles may vary. In some embodiments, the plurality of additive particles is dispersed heterogeneously within the matrix material. For example, in some embodiments, the composite particle comprises a greatest percentage by volume of the matrix material in an exterior surface region. In such embodiments, the composite particle may be described as comprising a central region extending from the center of the composite particle outward toward the exterior surface region, the central region comprising additive particles. In some embodiments, the exterior surface region, including the exterior surface of the particle, also comprises additive particles.

The heterogenous additive particle distribution may alternatively be described with reference to inner and outer regions. For example, in some embodiments, the composite particle may be described as having an inner region extending outward from the center to an outer region, said outer region extending outward from the inner region to the exterior surface, wherein said inner and outer regions are defined by a population density of additive particles, the inner region having a higher population density of additive particles relative to the outer region.

In other embodiments, the plurality of additive particles are disposed within the matrix material such that the distribution of additive particles is even from the center to the exterior surface. In other words, in certain embodiments, the composite particle does not comprise a greatest percentage by volume of the matrix material in an exterior surface region, and the percentage by volume of the matrix material remains relatively constant from the interior to the exterior of the particle.

The thickness of the exterior surface region of the composite particles may vary. In some embodiments, the thickness of the exterior surface region varies along the exterior surface of the composite particle. In some embodiments, the thickness of the exterior surface region may be described in relation to the diameter of the composite particle. For example, in some embodiments, the exterior surface region has a thickness in a range from about 0.1% to about 25% of the diameter of the composite particle. In some embodiments, the exterior surface region has a thickness of about 0.1%, about 0.5% about 1%, about 3%, about 5%, about 10%, about 15%, about 20% or about 25% of the diameter of the composite particle, or in a range between any of these values.

The nature of the additive particles may vary. For example, the additive particles may comprise functional particles, sacrificial particles, or both. Further, the additive particles may comprise voids formed by the thermal decomposition of sacrificial additive particles.

In some embodiments, the additive particles comprise functional particles. In some embodiments, the functional particles are electrochemically active. Within the context of the present disclosure, the term electrochemically active refers to materials which may take part in an electrochemical reaction by donating and/or accepting electrons. In some embodiments, the functional particles comprise or are silicon, germanium, tin, or a combination thereof. Within the context of the present disclosure, the term “electrochemically active material particles” refers to materials with a range of particle sizes suitable for use with polyimide or carbon gels as disclosed herein. In some embodiments, the functional particles comprise silicon.

In some embodiments, the functional particles comprise a sacrificial coating or layer. The sacrificial coating or layer forms void space surrounding the functional particle by exposing the composite particle to elevated temperature (e.g., during subsequent calcining). Within the context of the present disclosure, the term “sacrificial coating” or “sacrificial layer” refers to a coating or layer of material that is intended to be sacrificed or at least partially removed in response to thermal conditions experienced by the material (i.e., the sacrificial material can decompose when exposed to high temperatures). Suitable sacrificial materials for the coating or layer are described below with respect to sacrificial particles. The sacrificial material used for the coating or layer may be the same or different from the sacrificial particle material. In embodiments where the functional particles comprise a sacrificial coating or layer, and the composite material is calcined as described herein below, the matrix material comprises void space surrounding the functional particles, the void space formed by the thermal decomposition of the sacrificial coating.

In some embodiments, the additive particles comprise sacrificial particles. The sacrificial particles can be made of polymers, metals, natural and synthetic organics, salts, ceramic compounds or combination thereof. Suitable sacrificial materials for such particles include, but are not limited to, salts such as sodium chloride, metals such as zinc, siloxanes, polyolefins, polyurethanes, phenolics, melamine, cellulose acetate, polystyrenes, and combinations thereof. In some embodiments, the onset temperature of chemical decomposition of the sacrificial material is in the range of about 100° C. to about 700° C., about 100° C. to about 500° C., about 200° C. to about 400° C.

In some embodiments, the sacrificial material comprises a polymer. Polymers for use in the sacrificial material can be selected from a wide variety of thermoplastic resins, blends of thermoplastic resins, or thermosetting resins. Examples of thermoplastic resins that can be used include polyacetals, polyacrylics, styrene acrylonitrile, polyolefins, acrylonitrile-butadiene-styrene, polycarbonates, polystyrenes, polyethylene terephthalates, polybutylene terephthalates, polyamides such as, but not limited to Nylon 6, Nylon 6,6, Nylon 6,10, Nylon 6,12, Nylon 11 or Nylon 12, polyamideimides, polyarylates, polyurethanes, ethylene propylene rubbers (EPR), polyarylsulfones, polyethersulfones, polyphenylene sulfides, polyvinyl chlorides, polysulfones, polyetherimides, polytetrafluoroethylenes, fluorinated ethylene propylenes, polychlorotrifluoroethylenes, polyvinylidene fluorides, polyvinyl fluorides, polyetherketones, polyether etherketones, polyether ketone ketones, and the like, or a combination comprising at least one of the foregoing thermoplastic resins.

Examples of blends of thermoplastic resins that can be used in the sacrificial material include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, polyethylene terephthalate/polybutylene terephthalate, styrene-maleic anhydride/acrylonitrile-butadiene-styrene, polyether etherketone/polyethersulfone, styrene-butadiene rubber, polyethylene/nylon, polyethylene/polyacetal, ethylene propylene rubber (EPR), and the like, or a combination comprising at least one of the foregoing blends.

Examples of polymeric thermosetting resins that can be used in the sacrificial material include polyurethanes, epoxies, phenolics, polyesters, polyamides, silicones, and the like, or a combination comprising at least one of the foregoing thermosetting resins. Blends of thermosetting resins as well as blends of thermoplastic resins with thermosetting resins can be used. In some embodiments, the sacrificial particles comprise a polymer having a pyrolysis yield of less than 30 wt %, less than 20 wt %, less than 18 wt %, less than 15 wt %, less than 10 wt %, less than 8.0 wt %, or less than 5.0 wt %.

In some embodiments, the sacrificial particles comprise polymethylmethacrylate (PMMA), polyvinylpyrrolidone (PVP), polyvinyl acetate PVAc), polyvinyl alcohol (PVA), polyacrylonitrile (PAN), polypropylene oxide (PEO), polypropylene oxide (PPO), polyethyleneimine (PEI), polyurethane, poly(3,4-ethylenedioxythiophene, PEDOT), polyvinylbutyral, polyethylene oxide copolymer, polypropylene oxide copolymer, polycarbonate (PC), polyvinylchloride (PVC), polycaprolactone, polyvinylidene fluoride, polystyrene, or combinations thereof.

In some embodiments, the sacrificial particles comprise polystyrene, polyester, polymethacrylate, polyacrylate, polyethylene glycol, polyacid amides, polynorborene, or combinations thereof. In one aspect, the sacrificial particles comprise polymethyl methacrylate (PMMA).

In some embodiments, the sacrificial particles have a diameter of less than 5000 nm, less than 2000 nm, less than 1000 nm, less than 800 nm, less than 500 nm, less than 300 nm, less than 250 nm, less than 200 nm, less than 150 nm or less than 100 nm.

### Shaped Pores

In some embodiments, the matrix material comprises shaped pores, such as shaped pores formed by the thermal decomposition of at least a portion of the sacrificial particles. For avoidance of doubt, such shaped pores are different and distinct from the matrix pores present in the matrix material. In particular, the shaped pores are distinguished from the matrix pores at least by virtue of size. For example, the shaped pores generally have a diameter from about 0.1 to about 50,000 times the diameter of the matrix pores, such as in a range from about 0.1 times to about 1 time, or from about 1, about 10, about 100, or about 1000, to about 10,000, or about 50,000 times the diameter of the matrix pores. In some embodiments, the shaped pores have a diameter in a range from about 0.05 μm to about 15 μm, such as from about 0.05, about 0.1, or about 1, to about 10, or about 15 μm.

The shaped pores are also generally uniform in size. For example, in some embodiments, the shaped pores have a volume variation of less than about 20%.

In some embodiments, the functional particles each have a volume, the shaped pores each have a volume, and the matrix pores each have a volume, and the volume of each functional particle is less than the volume of a shaped pore and greater than the volume of a matrix pore. In some embodiments, the composite particle has a total volume of the shaped pores and a total volume of the functional particles, and the total volume of the functional particles is less than the total volume of the shaped pores. In some embodiments, the total volume of the shaped pores is in a range from about 0.1 to about 10 times the total volume of the functional particles, such as from about 0.1 to about 1, or from about 1 to about 10 times the total volume of the functional particles.

The shape of the shaped pores may vary. In some embodiments, the shaped pores have irregular shapes. In some embodiments, the shaped pores have distinct shapes. In some embodiments, the shaped pores are spherical pores. In some embodiments, the shaped pores are distorted spherical pores. In some embodiments, the distorted spherical pores include two or more interconnected spherical pores. In some embodiments, the distorted spherical pores are formed by thermal decomposition of two or more interconnected sacrificial particles.

The quantity of shaped pores present in the matrix material may vary, and the distribution of such shaped pores may also vary. For example, in some embodiments, the quantity of shaped pores present is higher toward the center of the composite particle. In other embodiments, the quantity of shaped pores present does not vary substantially from the center of the composite particle outward to the exterior surface of said particle.

In some embodiments, the shaped pores are connected to the matrix pores. In some embodiments, at least a portion of the functional particles are positioned adjacent to the shaped pores. In some embodiments, at least a portion of the functional particles are positioned inside the shaped pores.

In some embodiments, the amount of shaped pores present in the matrix material is determined by the amount of the sacrificial particles present in the matrix material prior to the thermal decomposition thereof.

In some embodiments, the composite particle comprises surface depressions projecting from an outer surface of the particle into the exterior surface region. In some embodiments, said surface depressions comprise one or more functional particles.

The distribution of matrix material, functional particles, sacrificial particles, shaped pores, surface dents, and void spaces according to embodiments of the disclosure may be more readily described with reference to the drawings.

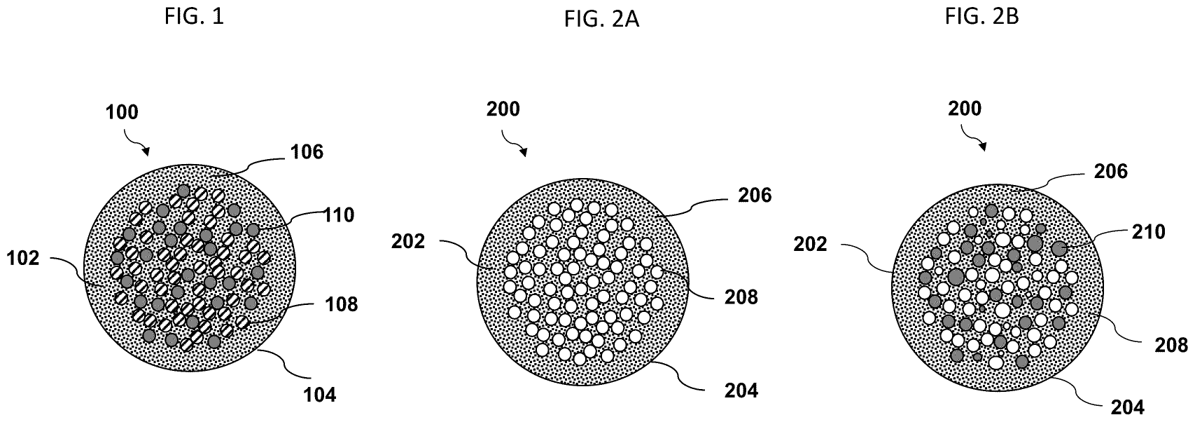

FIG. 1 provides a schematic illustration of a composite particle 100 according to a non-limiting aspect of the disclosure, before any calcining is performed. With reference to FIG. 1, the composite particle 100 comprises a matrix material 102 as described herein. The composite particle 100 comprises an exterior surface 104, and an exterior surface region 106, extending inward from the exterior surface 104, and which contains a greatest percentage by volume of the matrix material 102. The composite particle 100 further comprises sacrificial particles 108 and functional particles 110. The sacrificial particles 108 and functional particles 110 are more abundant in the region extending from the particle center outward toward the exterior surface region 106.

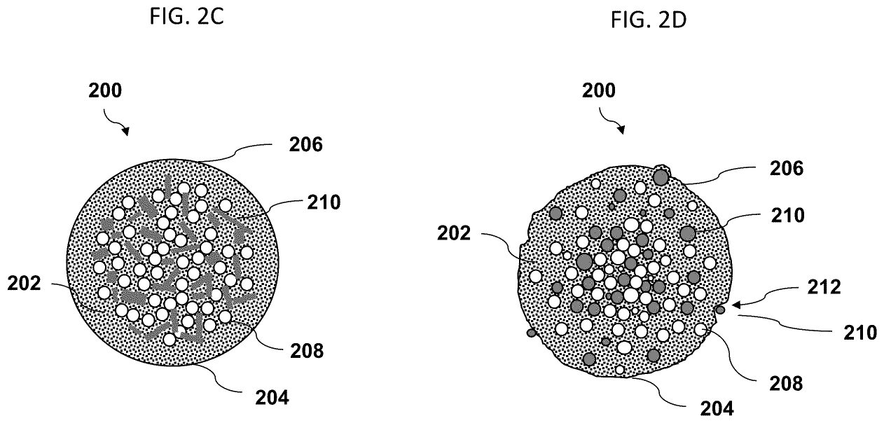

FIG. 2A provides a schematic illustration of a composite particle 200 according to a non-limiting aspect of the disclosure, after calcining is performed. With reference to FIG. 2A, the composite particle 200 comprises a matrix material 202 as described herein. The composite particle 200 comprises an exterior surface 204, and an exterior surface region 206, extending inward from the exterior surface 204, and which contains a greatest percentage by volume of the matrix material 202. The composite particle 200 further comprises shaped pores 208, resulting from calcining sacrificial particles 108 as described herein. The shaped pores 208 are more abundant in the region extending from the particle center outward toward the exterior surface region 206.

FIG. 2B provides a schematic illustration of another composite particle 200 according to a non-limiting aspect of the disclosure, after calcining is performed. With reference to FIG. 2B, the composite particle 200 comprises a matrix material 202 as described herein. The composite particle 200 comprises an exterior surface 204, and an exterior surface region 206, extending inward from the exterior surface 204, and which contains a greatest percentage by volume of the matrix material 202. The composite particle 200 further comprises shaped pores 208, resulting from calcining sacrificial particles 108 as described herein, and functional particles 210, as described herein. The shaped pores 208 and functional particles 210 are more abundant in the region extending from the particle center outward toward the exterior surface region 206.

FIG. 2C provides a schematic illustration of another composite particle 200 according to a non-limiting aspect of the disclosure, after calcining is performed. With reference to FIG. 2C, the functional particles 210 vary in shape and size. In some embodiments, the functional particles have one or more shapes which include, but are not limited to, spherical, cubical, cylindrical, ellipsoidal, polyhedral, dendritic, and fractal. In some embodiments, the functional particles include forms such as nanorods, nanowires, nanotubes, nanodots, and combinations thereof.

FIG. 2D provides a schematic illustration of another composite particle 200 according to a non-limiting aspect of the disclosure, after calcining is performed. With reference to FIG. 2D, the composite particle 200 further comprises surface dents 212. In some embodiments, the surface dents are formed by thermal decomposition of sacrificial particles at least partially situated at the exterior surface 204. In some embodiments, the surface dents include one or more functional particles 210. As depicted in FIG. 2D, in some embodiments, the composite particle comprises functional particles 210 disposed on the exterior surface 204. FIG. 2D further illustrates that in some embodiments, the shaped pores 208 and/or functional particles 210 extend into the exterior surface region 206, although they are more densely populated toward the center of the composite particle 200.

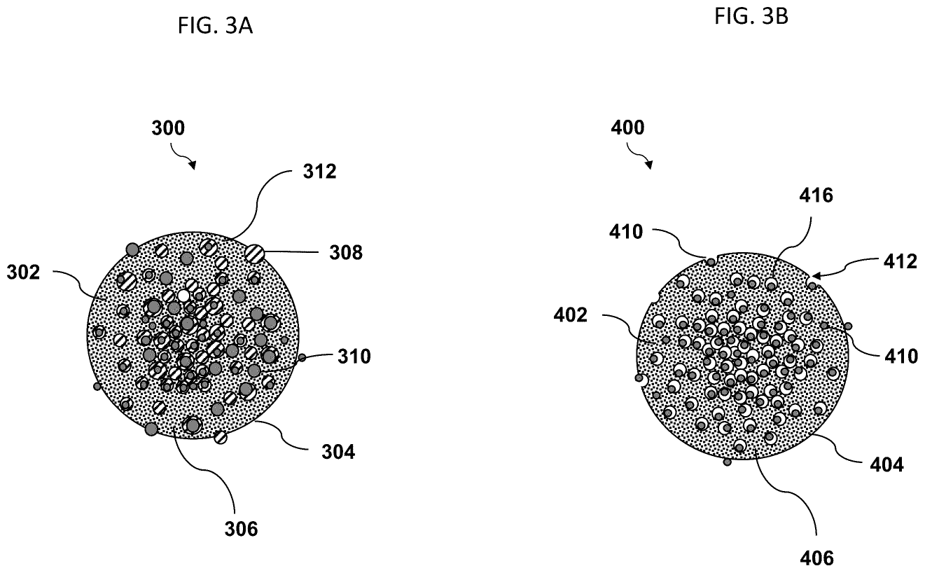

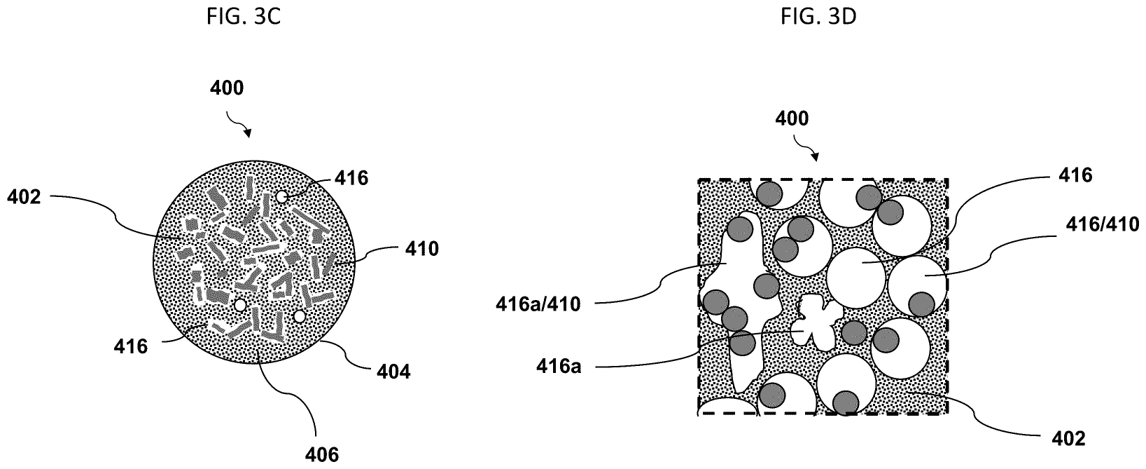

FIG. 3A provides a schematic illustration of a composite particle 300 according to a non-limiting aspect of the disclosure, before any calcining is performed. With reference to FIG. 3A, the composite particle 300 comprises a matrix material 302 as described herein. The composite particle 300 comprises an exterior surface 304, and an exterior surface region 306, extending inward from the exterior surface 304, and which contains a greatest percentage by volume of the matrix material 302. The composite particle 300 further comprises sacrificial particles 308, functional particles 310, and functional particles with a sacrificial coating layer (316).

FIG. 3B provides a schematic illustration of a composite particle 400 according to a non-limiting aspect of the disclosure, after calcining is performed. With reference to FIG. 3B, the composite particle 400 comprises a matrix material 402 as described herein. The composite particle 400 comprises an exterior surface 404, and an exterior surface region 406, extending inward from the exterior surface 404, and which contains a greatest percentage by volume of the matrix material 402. The composite particle 400 further comprises void spaces 416, resulting from calcining functional particles with a sacrificial coating (312) as described herein. As illustrated in FIG. 3B, many of the void spaces 416 contain a functional particle 410, although the composite particle 400 may also comprise functional particles 410 not within such void spaces. The functional particles 410 not within such void spaces may result from e,g., calcining functional particles which do not have a sacrificial coating (312). As depicted in FIG. 3B, in some embodiments, the composite particle 400 further comprises surface dents 412, which may include one or more functional particles 410.

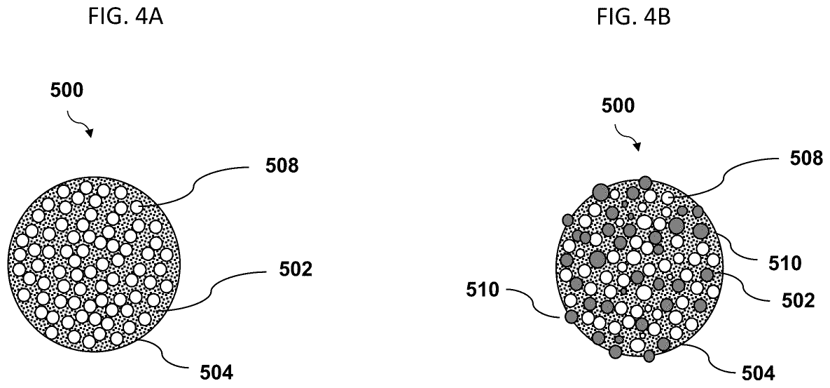

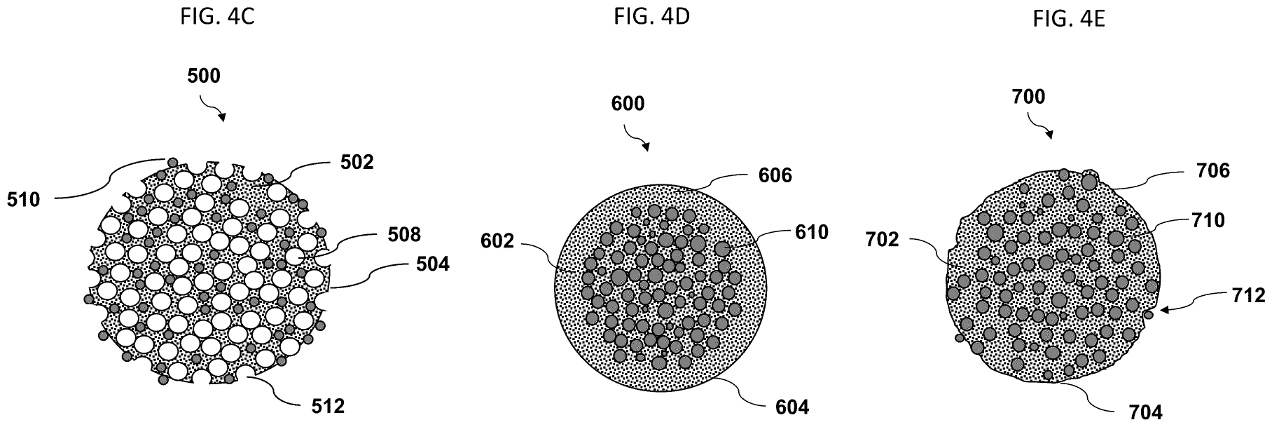

FIG. 3C provides a schematic illustration of another composite particle 400 according to a non-limiting aspect of the disclosure, after calcining is performed. With reference to FIG. 4C, the functional particles 410 and the void spaces 416 may vary in shape and size. In some embodiments, the functional particles may have irregular shapes disposed in similarly shaped voids. In some embodiments, the similarly shaped voids are formed by calcining the sacrificial materials which contour the functional particles. In some embodiments, at least a porton of the functional particles are rod-shaped and are disposed in rod-shaped voids.

FIG. 3D provides a schematic illustration enlarged relative to FIG. 3C and showing alternative orientations of void spaces 416 and functional particles 410 within matrix material 402. With reference to FIG. 3D, the composite material 400 may comprise void spaces 416, void spaces 416 including one or more functional particles 410, and may also comprise irregularly shaped void spaces 416a, such as irregularly shaped void spaces 416a including one or more functional particles 410. The irregularly shaped void spaces 416a may be the result of thermal decomposition of aggregates of two or more (e.g., three, or four, or even more) sacrificial particles.

As described herein above, in one aspect is provided a composite particle comprising a matrix material having an innate matrix porosity comprising matrix pores; and (i) a plurality of functional additive particles disposed within the matrix material and a plurality of sacrificial additive particles disposed within the matrix material; (ii) a plurality of voids disposed within the matrix material, said voids formed by the thermal decomposition of sacrificial additive particles; or (iii) a combination of a plurality of functional additive particles disposed within the matrix material and a plurality of voids disposed within the matrix material, said voids formed by the thermal decomposition of sacrificial additive particles.

FIG. 4A provides a schematic illustration of a composite particle 500 according to a non-limiting aspect of the disclosure, after calcining is performed, having a plurality of voids disposed within the matrix material, said voids formed by the thermal decomposition of sacrificial additive particles. With reference to FIG. 4A, the composite particle 500 comprises a matrix material 502 as described herein. The composite particle 500 comprises an exterior surface 504. The composite particle 500 further comprises voids 508, resulting from calcining sacrificial particles (108, 308) as described herein. The voids 508 are evenly distributed from the particle center outward toward the exterior surface 504.

FIG. 4B provides a schematic illustration of a composite particle 500 according to a non-limiting aspect of the disclosure, after calcining is performed, having a combination of a plurality of functional particles disposed within the matrix material and a plurality of voids disposed within the matrix material, said voids formed by the thermal decomposition of sacrificial additive particles. With reference to FIG. 4B, the composite particle 500 comprises a matrix material 502 as described herein. The composite particle 500 comprises an exterior surface 504. The composite particle 500 further comprises voids 508, resulting from calcining sacrificial particles (108, 308) as described herein. The voids 508 are evenly distributed from the particle center outward toward the exterior surface 504. The composite particle 500 further comprises functional particles 510, both within the matrix material 502 and disposed on the exterior surface 504.

FIG. 4C provides a schematic illustration of a composite particle 500 according to a non-limiting aspect of the disclosure, after calcining is performed, having a combination of a plurality of functional particles disposed within the matrix material and a plurality of voids disposed within the matrix material, said voids formed by the thermal decomposition of sacrificial additive particles, and further comprising surface dents. With reference to FIG. 4C, the composite particle 500 comprises functional particles 510, both within the matrix material 502 and disposed on the exterior surface 504, and surface dents 512.

FIG. 4D provides a schematic illustration of a composite particle 600 according to a non-limiting aspect of the disclosure, after calcining is performed, having a plurality of functional particles 610 disposed within the matrix material 602. With reference to FIG. 4D, the composite particle 600 comprises functional particles 610 within the matrix material 602. In this embodiment, the exterior surface region 606 comprises matrix material 602, but has a low concentration of functional particles 610 within the exterior surface region 606, and none on the exterior surface 604. Such composite particles have a relatively low surface area due to the high concentration of high surface area functional particles (e.g., silicon) within the center portion of the beads. As described further herein below, this morphology may be achieved when using an acid anhydride gelation agent (e.g., acetic anhydride). The low surface area of composite particles 600 can provide an improved first cycle efficiency and extended cycle life in electrochemical cells which include the composite particles relative to electrochemical cells of equivalent capacity that include higher surface area composite particles. Similar improvements to electrochemical performance have been illustrated in other battery materials such as the pitch coated beads disclosed in International Patent Application Publication Number WO2023/108106, in which surface area (BET) and first cycle efficiency (FCE) are shown to be inversely correlated. See, e.g., paragraph and Table 3 of WO2023/108106. The impact of surface area on battery cycle life of a mesoporous nanocarbon material is disclosed in, for example, Small 2018, 14 (12), 1703361.

FIG. 4E provides a schematic illustration of a composite particle 700 according to a non-limiting aspect of the disclosure, after calcining is performed, having a plurality of functional particles 710 disposed within the matrix material 702. With reference to FIG. 4E, the composite particle 700 comprises functional particles 710 within the matrix material 702. In this embodiment, the exterior surface region 706 comprises matrix material 702, and also includes functional particles 710 within the exterior surface region 706 and on the exterior surface 704, along with surface dents 712, optionally including functional particles in a portion thereof. Such composite particles have a relatively high surface area due to the high concentration of high surface area functional particles (e.g., silicon) within the exterior surface region 706 of the beads. As described further herein below, this morphology may be achieved when using an acid gelation agent (e.g., acetic acid) as a portion of the total amount of gelation agent. The low surface area of composite particles 700 can provide an improved first cycle efficiency and extended cycle life in electrochemical cells which include the composite particles relative to electrochemical cells of equivalent capacity that include higher surface area composite particles.

### II. Composite Particle Properties

As described above, the composite particles (e.g., having a matrix material which is or comprises an organogel or carbon) of the present disclosure may be in the form of an aerogel material, such as a xerogel or aerogel.

The physical properties of the composite particles may vary depending on the specific combination of variables utilized in their production, as described herein below. In some embodiments, the particles are prepared in an emulsion format. Prepared in such format, the particles may be described as beads, the diameter of which may vary. For example, in some embodiments, the beads (organogel or carbon) have a diameter in a range from about 1 micrometer to about 50 micrometers, such as about 1 micrometer, about 2 micrometers, about 3 micrometers, about 4 micrometers, about 5 micrometers, about 6 micrometers, about 7 micrometers, about 8 micrometers, about 9 micrometers, about 10 micrometers, about 15 micrometers, about 20 micrometers, about 25 micrometers, about 30 micrometers, about 35 micrometers, about 40 micrometers, about 45 micrometers, about 50 micrometers, or in a range between any two of these values. In certain embodiments, the beads have a diameter in a range from about 1 to about 15 μm. In some embodiments, the beads have a particle size D₁₀ in a range from about 5 to about 15 μm, or from about 5 to about 10 μm. In some embodiments, the beads have a particle size D₅₀ in a range from about 5 to about 25 μm, or from about 10 to about 15 μm. In some embodiments, the beads have a particle size D₉₀ in a range from about 15 to about 35 μm, or from about 10 to about 20 μm.

The density of the beads may vary. In some embodiments, the beads have a tap density in a range of about 0.2 g/cm³ to about 1.5 g/cm³, or from about 0.3 to about 1.3 g/cm³.

As described herein above, in some embodiments, the composite particles comprise functional particles, which are or comprise an electrochemically active material (e.g., silicon, germanium, tin, or a combination thereof). The amount of electrochemically active material (e.g., elemental silicon) present may vary. In some embodiments, the porous carbon composition contains greater than about 10% by weight of electrochemically active material. In some embodiments, the composite particles comprise from about 25% to 65% of electrochemically active material by weight, relative to the weight of the carbon matrix material. In some embodiments, the composite particles comprise about 25, about 30, about 35, about 40, about 45, about 50, about 55, about 60, or about 65% by weight of electrochemically active material.

The particle size of the electrochemically active material (e.g., elemental silicon) present in the composite particles may vary. In some embodiments, the electrochemically active material has a particle size less than about 150 nm. In some embodiments, the electrochemically active material has a particle size in the range of about 150 nm to about 500 nm. In some embodiments, the electrochemically active material has a particle size greater than about 500 nm.

### III. Electrode Materials and Energy Storage Devices

In another aspect is provided an electrode for a battery (e.g., a lithium-ion battery; LIB), the electrode comprising the composite particle as disclosed herein. Composite particles as disclosed herein are, in some embodiments, suitable for use as electrode materials within an energy storage device, for example as the primary anodic material in a LIB. Particularly, the shaped pores and/or void spaces present in the disclosed composite particles are designed, organized, and structured to accommodate particles of silicon or other suitable electrochemically active materials, and expansion of such particles upon lithiation in a LIB, for example. Alternatively, the shaped pores of the composite particles may be filled with sulfide, hydride, any suitable polymer, or other additive where there is benefit to contacting the additive with the matrix material of the composite to provide for an effective electrode.

The amount of anode material (i.e., the composite particle and optionally, a conductive material such as graphite) present in the anode electrode composition may vary. In some embodiments, the anode electrode composition comprises the anode material in an amount by weight in a range from about 70 to about 90%, on a dry weight basis, based on the total weight of the anode electrode composition. Generally, the anode electrode further comprises a binder material and conductive material, and the anode material is present as a layer on a substrate. The material of the substrate and the physical form of the substrate may vary. The anode substrate acts to collect electrons generated by electrochemical reactions of the battery electrode material or to supply electrons required for the electrochemical reactions. The substrate may be in the form of a foil, sheet, mesh, or film. The substrate thickness may vary. In some embodiments, the substrate has a thickness, prior to coating, from about 5 μm to about 40 μm. The substrate may be formed of a conductive material such as stainless steel, titanium, nickel, aluminum, copper, or an electrically conductive resin. In some embodiments, the substrate is a copper film.

In another aspect is provided a lithium-ion battery cell, module, or lithium-ion battery comprising a composite particle as described herein (e.g, as an anode). Such cells, module, or batteries may further comprise a cathode and a separator interposed between the cathode and the anode.

In yet another aspect is provided an energy storage system, an electronic device, or an electric vehicle comprising a composite particle as disclosed herein, or an electrode, lithium-ion battery cell, module, or lithium-ion battery comprising such a composite particle.

### IV. Method of Preparing Composite Particles

The disclosure generally provides methods of preparing composite particles comprising a matrix material and a plurality of sacrificial particles, functional particles, or both, disposed within the matrix material.

In one aspect is provided a method of preparing composite particles comprising a matrix material and a plurality of sacrificial particles disposed within the matrix material. The method generally comprises providing a solution of one or more matrix material precursors in a solvent, suspending additive particles in the solution, forming an emulsion, forming organogel particles from the emulsion, and optionally, drying the organogel particles.

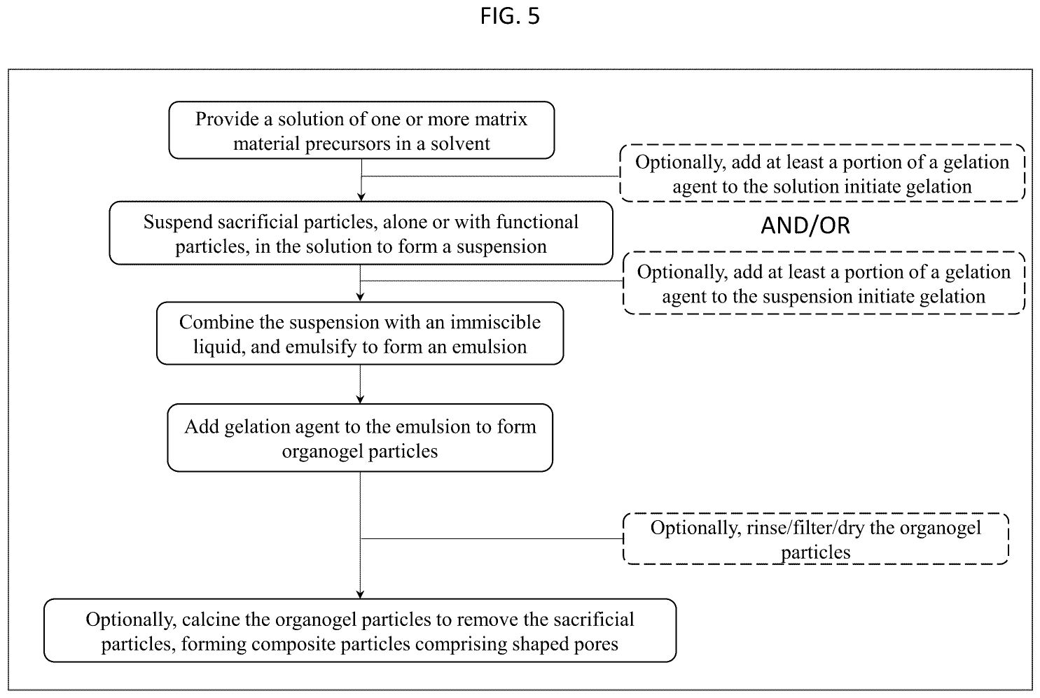

FIG. 5 provides a general, non-limiting flow chart illustrating the method according to an aspect of the disclosure. With reference to FIG. 5, in one aspect, the method comprises:
providing a solution of one or more matrix material precursors in a solvent;
suspending sacrificial particles in the solution to form a suspension;
combining the suspension with an immiscible liquid to form a mixture;
emulsifying the mixture to provide a plurality of droplets, wherein each droplet in the plurality comprises a plurality of the sacrificial particles;
adding a gelation agent to the emulsified mixture, forming organogel particles from each droplet; and
optionally, drying the organogel particles.

The individual method steps and variations of the generalized method are described further herein below.

### Matrix Material and Precursors

The method generally comprises providing a solution of one or more matrix material precursors in a solvent. The matrix material may vary. For example, in some embodiments, the matrix material is an organogel. In some embodiments, the matrix material is a carbon material obtained by calcining an organogel. In embodiments where the matrix material is an organogel or a carbon material obtained by calcining an organogel, the matrix material precursors comprise materials which are allowed to react to form an organogel. These precursors will vary depending on the desired organogel.

In some embodiments, the organogel comprises a polyimide. In such embodiments, the matrix material precursors comprise a polyamic acid. Polyamic acids are polymeric amides having repeat units comprising carboxylic acid groups, carboxamido groups, and aromatic or aliphatic moieties which comprise the diamine and tetracarboxylic acid from which the polyamic acid is derived. A “repeat unit” as defined herein is a part of the polyamic acid (or corresponding polyimide) whose repetition would produce the complete polymer chain (except for the terminal amino groups or unreacted anhydride termini) by linking the repeat units together successively along the polymer chain. One of skill in the art will recognize that the polyamic acid repeat units result from partial condensation of tetracarboxylic acid dianhydride carboxyl groups with the amino groups of a diamine.

In some embodiments, the polyamic acid is purchased and dissolved in the solvent to provide the polyamic acid solution. In some embodiments, the polyamic acid is any commercially available polyamic acid.

In some embodiments, the polyamic acid is previously prepared, and dissolved in the solvent to provide the polyamic acid solution. For example, in some embodiments, the polyamic acid has been previously formed (“pre-formed”) and isolated, e.g., prepared by reaction of a diamine and a tetracarboxylic dianhydride in an organic solvent according to conventional synthetic methods. In either case, whether purchased or prepared and isolated, a suitable polyamic acid is in substantially pure form. Pre-formed and isolated or commercially available polyamic acids may be in, for example, solid form, such as a powder or crystal form, or in liquid form.

In other embodiments, the polyamic acid solution is obtained by in situ preparation from polyamic acid precursors (diamine and tetracarboxylic dianhydride) according to known methods.

In any of the foregoing embodiments, the structure of suitable polyamic acids may vary. In some embodiments, the polyamic acid has a structure represented by Formula I:

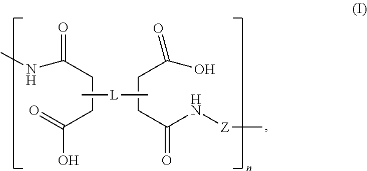

wherein:
Z is a group connecting the two terminal amino groups of a diamine;
L is a group connecting the carboxyl groups; and
n is an integer indicating the number of polyamic acid repeat units, and which determines the molecular weight of the polyamic acid.

In some embodiments, Z is aliphatic (e.g., alkyl, alkenyl, alkynyl, or cycloalkyl) as described herein above. Accordingly, in some embodiments, the polyamic acid comprises as the repeat unit an amide of an aliphatic diamine. In some embodiments, the polyamic acid comprises as the repeat unit an amide of an alkane diamine having from 2 to 12 carbon atoms (i.e., C2 to C12). In some embodiments, the polyamic acid comprises as the repeat unit an amide of a C2 to C6 alkane diamine, such as, but not limited to, ethylenediamine, 1,3-diaminopropane, 1,4-diaminobutane, 1,5-diaminopentane, or 1,6-diaminohexane. In some embodiments, one or more of carbon atoms of the C2 to C6 alkane of the diamine is substituted with one or more alkyl groups, such as methyl.

In some embodiments, Z is aryl as described herein above. Accordingly, in some embodiments, the polyamic acid comprises as the repeat unit an amide of an aryl diamine. In some embodiments, the polyamic acid comprises as the repeat unit an amide of a phenylene diamine, a diaminodiphenyl ether, or an alkylenedianiline. In some embodiments, the polyamic acid comprises as the repeat unit an amide of an aryl diamine selected from the group consisting of 1,3-phenylenediamine, 1,4-phenylenediamine, 4,4′-diaminodiphenyl ether, 4,4′-methylenedianiline, and combinations thereof. In some embodiments, the polyamic acid comprises as the repeat unit an amide of an aryl diamine selected from the group consisting of 1,4-phenylenediamine, 4,4′-methylenedianiline, 4,4′-diaminodiphenyl ether. In some embodiments, the polyamic acid comprises as the repeat unit an amide of an aryl diamine which is 1,4-phenylenediamine (PDA).

In some embodiments, L comprises an alkyl group, a cycloalkyl group, an aryl group, or a combination thereof, each as described herein above. In some embodiments, L comprises an aryl group. In some embodiments, L comprises a phenyl group, a biphenyl group, or a diphenyl ether group. In some embodiments, the polyamic acid comprises as the repeat unit an amide of a tetracarboxylic acid selected from the group consisting of benzene-1,2,4,5-tetracarboxylic acid, [1,1′-biphenyl]-3,3′,4,4′-tetracarboxylic acid, 4,4′-oxydiphthalic acid, 4,4′-sulfonyldiphthalic acid, 4,4′-carbonyldiphthalic acid, 4,4′-(propane-2,2-diyl)diphthalic acid, 4,4′-(perfluoropropane-2,2-diyl)diphthalic acid, naphthalene-1,4,5,8-tetracarboxylic acid, 4-(2-(4-(3,4-dicarboxyphenoxy)phenyl) propan-2-yl) phthalic acid, perylene tetracarboxylic acid, and combinations thereof. In some embodiments, the polyamic acid comprises as the repeat unit an amide of a tetracarboxylic acid which is benzene-1,2,4,5-tetracarboxylic acid.

### Solvent

The solvent utilized to provide the matrix material precursor solution may vary based on, for example, the particular matrix material precursors and the desired properties of the matrix material (e.g., an organogel). For example, the solvent may be water in cases where the precursor is water soluble. In particular embodiments, the matrix material is a polyimide, polyamic acid, or a combination thereof, the matrix material precursor is a polyamic acid salt, and the solvent is water. In other embodiments, the solvent is a polar, aprotic organic solvent. Such organic solvents may be utilized for the preparation of organogel matrix materials, including but not limited to polyimide and polyamic acid organogels. In some embodiments, the solvent is N,N-dimethylacetamide, N,N-dimethylformamide, N-methylpyrrolidone, or a combination thereof.

### Suspension

With continued reference to FIG. 5, the method comprises suspending sacrificial particles, functional particles, or both in the precursor solution to form a suspension. The sacrificial and functional particles are as described herein above, including functional particles having a sacrificial coating, also as described herein above.

### Sacrificial Particles

In some embodiments, the method comprises suspending sacrificial particles in the solution. Such particles, during subsequent processing as described below, are removed (e.g., by exposure to elevated temperature). Upon removal of the sacrificial particles, a hollow region (pore) remains in the composite particle in the space formerly occupied by the sacrificial particle. As described herein above, such hollow regions are referred to as shaped pores to distinguish these pores from the pores comprising the innate porosity of the matrix material.

Various materials can be utilized as sacrificial particles, but generally, they are materials which decompose upon thermolysis, or are readily dissolved away during processing. In some embodiments, the sacrificial particles are decomposed or dissolved completely. Alternatively, the sacrificial particles may be partially decomposed or dissolved, leaving a low level of residue remaining in the composite particles. In some embodiments, the sacrificial particles comprise a salt, such as an alkali metal or metal salt, a metal, or a polymer. In some embodiments, the sacrificial particles comprise sodium chloride, zinc, or a zinc salt. In some embodiments, the sacrificial particles have a carbonization yield of less than about 20 wt %. In some embodiments, the temperature of chemical decomposition of the sacrificial particles is in the range of about 100° C. to about 850° C. In some embodiments, the sacrificial particles comprise polymethylmethacrylate (PMMA). In some embodiments, the sacrificial particles comprise a polyamic acid (PAA).

### Functional Particles

In some embodiments, the method comprises suspending functional particles in the solution. In some embodiments, the functional particles are electrochemically active. In particular embodiments, the functional particles comprise or are silicon, germanium, tin, or a combination thereof.

In some embodiments, the functional particles comprise a sacrificial coating, also referred to herein as a sacrificial layer. Suitable sacrificial coatings decompose completely upon thermolysis or are readily dissolved away during processing. Suitable sacrificial coatings are described herein above, and may include polymers, metals, natural and synthetic organics, salts, ceramic compounds, or combinations thereof. In some embodiments, the sacrificial coating material has a carbonization yield of less than about 20 wt %. In some embodiments, the temperature of chemical decomposition of the sacrificial coating material is in the range of about 100° C. to about 850° C. In some embodiments, the sacrificial layer is formed from a material selected from polymethylmethacrylate (PMMA), polyvinylpyrrolidone (PVP), polyvinyl acetate PVAC), polyvinyl alcohol (PVA), polyacrylonitrile (PAN), polypropylene oxide (PEO), polypropylene oxide (PPO), polyethylene oxide copolymer, polypropylene oxide copolymer, polycarbonate (PC), polyvinylchloride (PVC), polycaprolactone, polyvinylidene fluoride, polystyrene or combination thereof. In some embodiments, the sacrificial coating comprises PMMA. In some embodiments, the sacrificial layer is PMMA.

Functional particles comprising a sacrificial coating or layer may be provided by various methods, depending at least in part on the nature of the coating. Described here are methods of providing electrochemically active particles comprising a sacrificial layer. The method begins with electrochemically active particles (e.g., silicon) having a known, desired particle size, shape, porosity and other material attributes that are substantially similar. Generally, the surface is oxidized to obtain hydroxyl functional groups on the surface. Oxidizing the surface of electrochemically active particles may lead to complete or partial oxidation of surface groups (e.g., Si—H). That is, all or certain percentage of surface groups (e.g., Si—H) on the surface of the particles are converted to —OH groups surface groups (e.g., Si—OH) after the oxidation process. The particles may be oxidized in a single or multiple step(s).

The oxidation can be thermal (e.g., at elevated temperatures under air), chemical (e.g., acid and/or oxidizing agent), electrochemical, or combinations thereof. Oxidizing a surface of the particles may comprise treatment with an oxidizing agent such as hydrogen peroxide (H₂O₂). Oxidizing a surface of the particles may comprise an acid treatment step. In some embodiments, the acid treatment step comprises the use of sulfochromic acid. In some embodiments, the acid treatment step comprises a step of sonicating the particles for a certain period of time, e.g., at least 5 minutes, at least 10 minutes, at least 20 minutes, at least 30 minutes, or at least 60 minutes. Oxidizing a surface of the particles may comprise a step of pyrolysis at a temperature in a range of about 300, about 400, or about 500, to about 600, about 650, about 700, about 800, about 850, or about 900° C. In some embodiments, the temperature is about 650° C.

The sacrificial layer is then formed on at least a portion of a surface of the electrochemically active material particles. The formation of sacrificial layer on the surface of the particles is performed before introducing the particles into the solution of the matrix material precursors. In some embodiments, the sacrificial layer is or comprises a polymer (e.g., PMMA). In such embodiments, forming the sacrificial layer comprises: i. grafting a polymer initiator on the surface of the particles to react with a monomer; and ii. polymerizing the monomer on the surface of the particles to form the sacrificial layer. In the first step, the particles (e.g., silicon) have hydroxyl functional groups on the surface thereof as described above which covalently react with a functional silane group. The step of covalently reacting hydroxyl groups on the surface of the particles includes the use of at least one functional group selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof. In some embodiments, 3-aminopropyltriethoxysilane (APTES) may be used as the functional silane group. Surface hydroxyl groups react with the silane groups in a polar solvent (e.g., ethanol).

After covalently attaching the at least one functional group (e.g., APTES) on the surface of the electrochemically active material particles to form particles comprising-NH₂ groups on the surface, a polymer initiator is grafted on the surface of the particles for further reaction with a monomer. In some embodiments, the polymer initiator comprises azobis(4-cyanovaleric acid) (ACPA), 2,2′-azobis(2-amidinopropane) hydrochloride (V50), ammonium persulfate, 2,2′-azobis(N,N′-dimethylene isobutyramidine) dihydrochloride (VA044), and ammonium persulfate/sodium meta bisulfite. In some embodiments, the polymer initiator comprises azobis(4-cyanovaleric acid) (ACPA).

Grafting a polymer initiator on the surface of the electrochemically active material particles takes place in a polar solvent (e.g. ethanol). The monomer initiators on the surface the particles undergo a polymerization reaction with a monomer, e.g., methyl methacrylate. The monomer chosen for the polymerization reaction depends on the type of the sacrificial layer that is desired on the surface. The polymerization reaction can take place in a polar solvent (e.g., water). The polymerization reaction takes place at a temperature higher than 25° C.

The thickness of the sacrificial layer may vary. In some embodiments, the sacrificial layer has a thickness of less than or equal to about 500 nm, or a thickness between about 100 nm and about 60 nm, or a thickness of about 60 nm to 0.3 nm. In some embodiments, the sacrificial layer has a thickness in the range of about 20% to about 0.01% of the diameter of the electrochemically active material particle.

### Emulsion

With continued reference to FIG. 5, the method comprises combining the suspension with an immiscible liquid to form a mixture and emulsifying the mixture. The immiscible liquid may vary. Suitable immiscible liquids include, but are not limited to, oils such as silicone oil or mineral oil, aliphatic hydrocarbons, aromatic hydrocarbons, and chlorinated hydrocarbons. In some embodiments, the immiscible liquid is a C5-C12 aliphatic or aromatic hydrocarbon. In some embodiments, the immiscible liquid is hexane. In particular embodiments, the immiscible liquid is mineral spirits or a silicone oil.

The method comprises emulsifying the mixture to provide a plurality of droplets, wherein each droplet in the plurality comprises a plurality of the sacrificial particles, and optionally the functional particles. The emulsification generally comprises a form of agitation (e.g., stirring) to form an emulsion, which may be stable or temporary. Exemplary embodiments of agitation include magnetic stirring (up to about 600 rpm), mechanical mixing (up to about 1500 rpm) and homogenization (i.e., mixing at up to about 9000 rpm). In some embodiments, mixing is performed under high-shear conditions (e.g., using a high-shear mixer or homogenizer). Fluid undergoes shear when one area of fluid travels at a different velocity relative to an adjacent area. A high-shear mixer (homogenizer) uses a rotating impeller or high-speed rotor, or a series of such impellers or inline rotors, to “work” the fluid, creating flow and shear. The tip velocity (i.e., the speed encountered by the fluid at the outside diameter of the rotor), will be higher than the velocity encountered at the center of the rotor, with this velocity difference creating shear. Generally, higher shear results in smaller droplets, producing smaller particles.

In some embodiments, a surfactant is utilized in the suspension, the immiscible liquid, or both. As used herein, the term “surfactant” refers to a substance which aids in the formation and stabilization of emulsions by promoting dispersion of hydrophobic and hydrophilic (e.g., oil and water) components. The surfactant may vary. Suitable surfactants are generally non-ionic, and include, but are not limited to, polyethylene glycol esters of fatty acids, propylene glycol esters of fatty acids, polysorbates, polyglycerol esters of fatty acids, sorbitan esters of fatty acid, and the like. Suitable surfactants have an HLB number ranging from about 0 to about 20. In some embodiments, the HLB number is from about 3.5 to about 6. As will be understood by one skilled in the art, HLB is the hydrophilic-lipophilic balance of an emulsifying agent or surfactant is a measure of the degree to which it is hydrophilic or lipophilic. The HLB value may be determined by calculating values for the different regions of the molecule, as described by Griffin in Griffin, William C. (1949), “Classification of Surface-Active Agents by ‘HLB’” (PDF), Journal of the Society of Cosmetic Chemists, 1 (5): 311-26 and Griffin, William C. (1954), “Calculation of HLB Values of Non-Ionic Surfactants” (PDF), Journal of the Society of Cosmetic Chemists, 5 (4): 249-56, and by Davies in Davies JT (1957), “A quantitative kinetic theory of emulsion type, I. Physical chemistry of the emulsifying agent” (PDF), Gas/Liquid and Liquid/Liquid Interface, Proceedings of the International Congress of Surface Activity, pp. 426-38. HLB value may be determined in accordance with the industry standard textbook, namely “The HLB SYSTEM, a time-saving guide to emulsifier selection” ICI Americas Inc., Published 1976 and Revised, March 1980.

Specific examples of suitable surfactants generally include, but are not limited to: polyoxyethylene-sorbitan-fatty acid esters; e.g., mono- and tri-lauryl, palmityl, stearyl and oleyl esters; e.g., products of the type known as polysorbates and commercially available under the trade name Tween®; polyoxyethylene fatty acid esters, e.g., polyoxyethylene stearic acid esters of the type known and commercially available under the trade name Myrj®; polyoxyethylene ethers, such as those available under the trade name Brij®; polyoxyethylene castor oil derivatives, e.g., products of the type known and commercially available as Cremophors®, sorbitan fatty acid esters, such as the type known and commercially available under the name Span® (e.g., Span® 80); polyoxyethylene-polyoxypropylene co-polymers, e.g., products of the type known and commercially available as Pluronic® or Poloxamer®; glycerol triacetate; and monoglycerides and acetylated monoglycerides, e.g., glycerol monodicocoate (Imwitor® 928), glycerol monocaprylate (Imwitor® 308), and mono- and di-acetylated monoglycerides. In some embodiments, the one or surfactants comprise a commercially available polymeric surfactant of the type known under the trade name Hypermer® (Croda Industrial Chemicals; Edison, NJ, USA).

In some embodiments, the one or more surfactants comprise Tween® 20, Tween® 80, Span® 20, Span® 40, Span® 60, Span® 80, or a combination thereof. In some embodiments, the surfactant is Span® 20, Tween® 80, or a mixture thereof. In some embodiments, the one or more surfactants is Hypermer® B246SF. In some embodiments, the one or more surfactants is Hypermer® A70.

The concentration of the surfactant may vary. In some embodiments, the surfactant, or a mixture of surfactants, is present in the water-immiscible solvent in amount by weight from about 1 to about 5%, such as about 1, about 2, about 3, about 4, or about 5%.

### Gelation and Gelation Agent

With continued reference to FIG. 5, a gelation agent is added to the emulsified mixture, forming organogel particles from each droplet. Without wishing to be bound by theory, it is believed that in some embodiments, the droplets in the emulsion isolate the sacrificial particles from the gelation agent, thereby minimizing the reaction therebetween.

The gelation agent may vary depending on the matrix material precursors utilized and the desired organogel identity and properties. In some embodiments, the organogel comprises or is a polyamic acid and the matrix material precursors comprise a salt of a polyamic acid (e.g., an ammonium salt). In such embodiments, the gelation agent is generally an acid, for example, an organic acid or a mineral acid. In some embodiments, the acid is a mineral acid, such as hydrochloric, sulfuric, or phosphoric acid. In some embodiments, the acid is an organic acid. The organic acid may vary, but is typically a lower carboxylic acid, including, but not limited to, formic, acetic, or propionic acid. In some embodiments, the acid is acetic acid.

In some embodiments, the organogel comprises or is a polyimide and the matrix material precursors comprise a polyamic acid. In such embodiments, the gelation agent is generally a dehydrating agent added to initiate and drive imidization of the polyamic acid. The structure of the dehydrating agent may vary but is generally a reagent that is at least partially soluble in the reaction mixture, reactive with the carboxylate groups of the polyamic acid (or a salt thereof, such as an ammonium salt), and effective in driving the imidization of the polyamic acid carboxyl and amide groups, while having minimal reactivity with the solvents present. One example of a class of suitable dehydrating agents is the carboxylic acid anhydrides, such as acetic anhydride, propionic anhydride, and the like. In some embodiments, the gelation agent is acetic anhydride.

The quantity of gelation agent (e.g., acetic anhydride) used may vary based on, e.g., the quantity of polyamic acid, the desired gelation time, and other factors. For example, in some embodiments, the gelation agent is present in various molar ratios with the polyamic acid. The molar ratio of the dehydrating agent to the polyamic acid may vary according to desired reaction time, reagent structure, and desired material properties. In some embodiments, the molar ratio is from about 2 to about 10, such as from about 2, about 3, about 4, or about 5, to about 6, about 7, about 8, about 9, or about 10. In some embodiments, the ratio is from about 4 to about 5.

In some embodiments, the gelation agent is added solely to the emulsion, and the gelation of the precursors occurs gradually from the exterior surface of the droplet toward the center. In other embodiments, at least a portion of the gelation agent is added to the solution, to the suspension, or both to initiate gelation. In some embodiments, at least a portion of the gelation agent is added to the suspension initiate gelation. In some embodiments, at least a portion of the gelation agent is added to the solution to initiate gelation. In some embodiments, at least a portion of the gelation agent is added to both the solution and the suspension to initiate gelation. In any of these embodiments where a portion of the gelation agent is added prior to emulsion formation, any remaining gelation agent intended to be added is then added to the emulsion.

Surprisingly, according to the present disclosure, it has been found that in some embodiments, addition of a portion of the gelation agent to the suspension increases the viscosity of the suspension, thereby enhancing dispersion of the sacrificial particles in the suspension. Further, it has been surprisingly discovered that in some embodiments, addition of a portion of the gelation agent to the suspension creates a viscosity gradient within the droplets, and the viscosity gradient forces sacrificial particles toward a center of the droplets, such that the exterior surface region of the composite particles has a deficit of sacrificial particles relative to the central region. Schematic, non-limiting illustrations of composite particles produced in the presence of such viscosity gradients are provided in FIGS. 1, 2A-2D, 3A-3D, and 4D and features thereof are described herein above.

It has been surprisingly found that, in certain embodiments, adding the entirety of the gelation agent to the emulsion does not produce a viscosity gradient, and the distribution of particles (sacrificial, functional, or both, and shaped pores from the thermal decomposition of sacrificial particles) was relatively consistent across the diameter of the particle from center to exterior surface. Further, the exterior surface region and exterior surface of such composite particles tended to have a higher concentration of voids, surface dents, and functional particles than composite particles prepared with a portion of the gelation agent added prior to emulsification. Schematic, non-limiting illustrations of composite particles produced in the relative absence of viscosity gradients are provided in FIGS. 4A-4C and features thereof are described herein above.

It was further surprisingly found that the combination of polyamic acid salt as matrix material precursor and acetic acid as the reactant or gelation agent (producing polyamic acid organogel as the matrix material) resulted in gelation of the droplets from the outside in, similarly resulting in the morphology illustrated in FIGS. 4A-4C.

While the morphology illustrated in FIGS. 4A-4C (relative abundance of pores on the exterior surface) may be useful in certain applications, it is generally deemed undesirable in composite materials for battery electrodes as it allows electrolyte to enter the composite particles. In contrast, as described herein above, the presence of a relative abundance of shaped pores in the interior of the composite particles beneficially allows for electroactive (e.g., silicon) material expansion.

When a portion of the total quantity of gelation agent is added to the solution and/or suspension, the amount of said portion can vary. In some embodiments, the portion is from about 10% to about 50% of the total amount of gelation agent, such as about 10, about 15, about 20, about 25, about 30, about 35, about 40, about 45, or about 50% of the total amount of gelation agent. In some embodiments, the portion is about 25%. In particular embodiments, about 25% of the total amount of gelation agent is added to the suspension, with the remaining 75% added to the emulsion. Notably, it was found according to the present disclosure that acetic anhydride interacted with the sacrificial material PMMA, leading to a lower incorporation of sacrificial particles in such embodiments, with a corresponding reduction in shaped pores. Without wishing to be bound by theory, it is believed that selection of each of the combination of sacrificial particle material, matrix material, gelation agent, and quantity/timing of gelation agent addition in combination have a profound impact on composite particle morphology. For example, it has been found according to the present disclosure that when a polyamic acid is gelled in the presence of acetic acid, and PMMA is the sacrificial particle material, the aforementioned-reduction in sacrificial particle incorporation was avoided but may require a higher viscosity of the gelation mixture (precursor solution plus acetic acid) to prevent agglomeration of the functional particles, depending on the loading and size of the functional particles.

Irrespective of the timing of gelation agent addition and species, the temperature at which the gelation is allowed to proceed may vary, but is generally less than about 50° C., such as from about 10 to about 50° C., or from about 15 to about 25° C.

Gelation is allowed to proceed for a period of time sufficient to provide organogel particles. The time required for complete gelation may vary. The period of time may vary based on many factors, such as the desirability of aging the material, but will generally be between a few minutes and a few hours. In some embodiments, gelation occurs in about 15 minutes or less. In some embodiments, an additional solvent, e.g., water or ethanol, can be added after gelation to produce smaller particles (e.g., beads) and reduce agglomeration of large clusters of beads.

### Alternative Methods of Forming Organogel Particles

The sequence of operations described above may be varied. For example, the sacrificial particles and/or the functional particles may be added to the solution of matrix precursors at different points relative to the emulsification and the initiation of gelation. Further, the gelation agent may be added in portions at different time points or may be added in a single portion at only one time point. Accordingly, various permutations of the disclosed method are contemplated herein, and certain such alternatives or specific implementations of the general method are further described below.

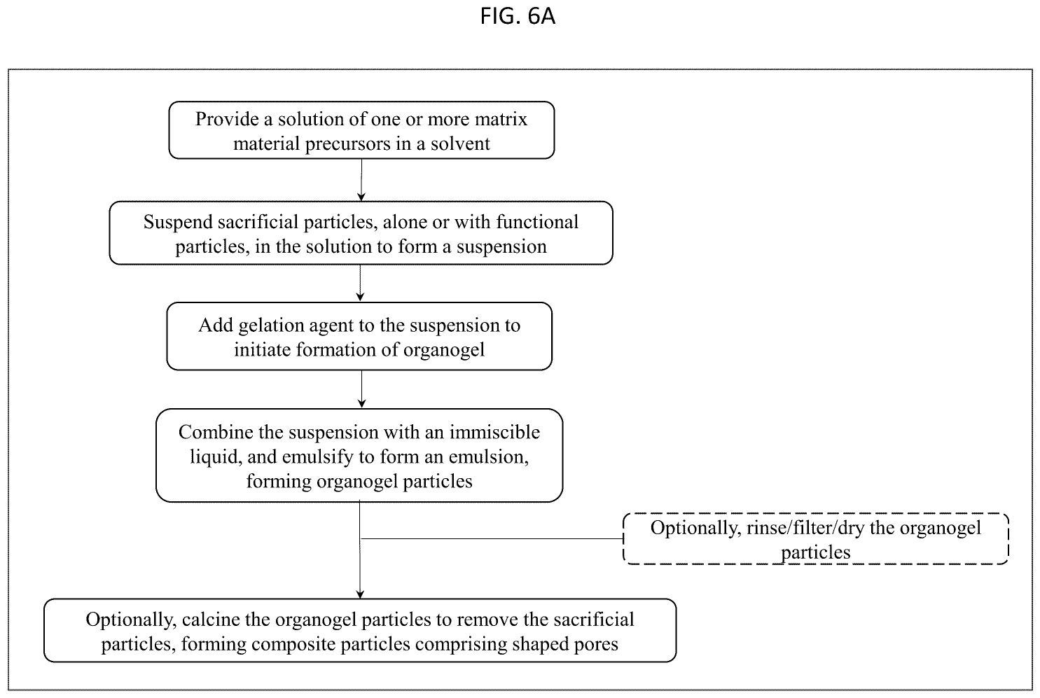

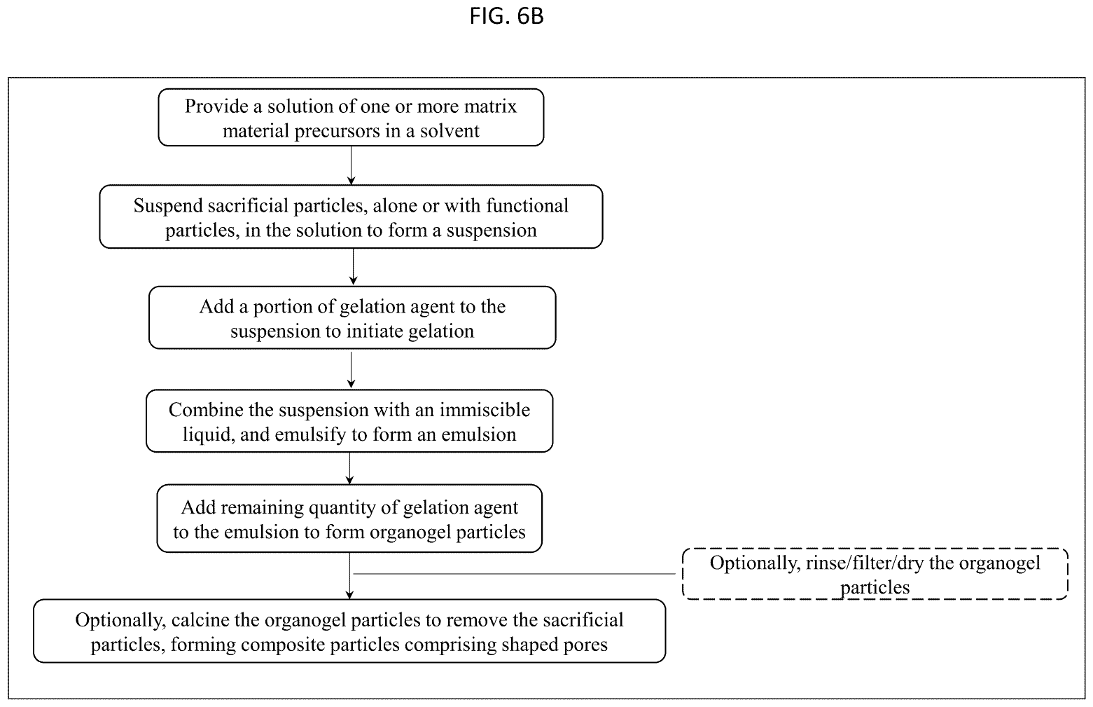

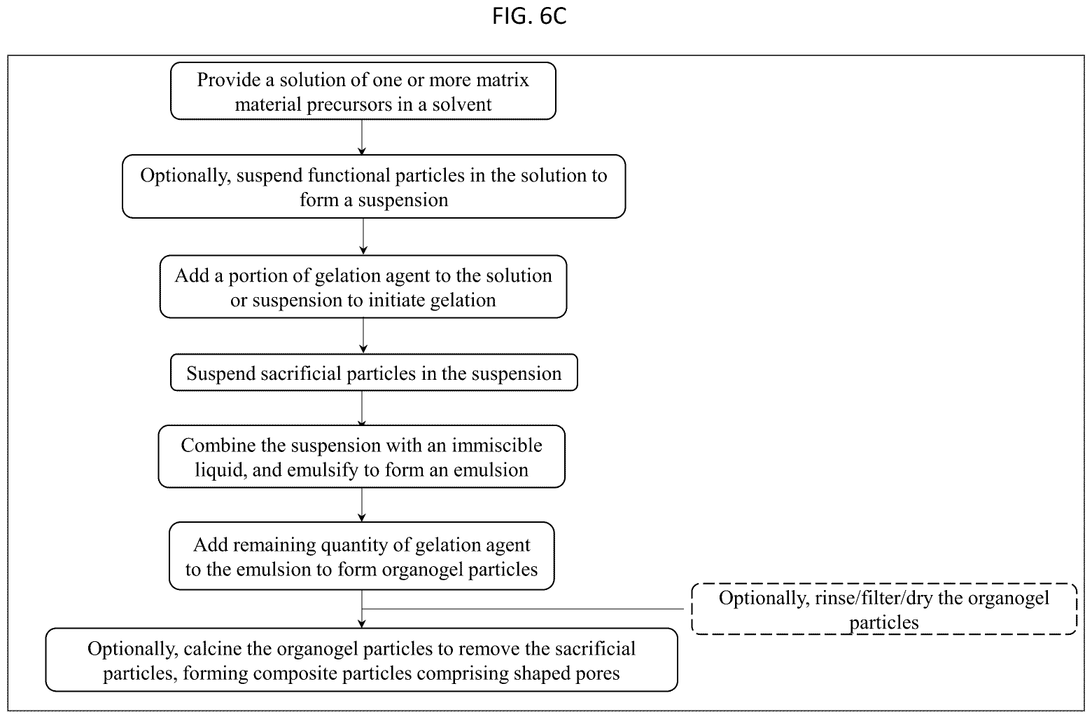

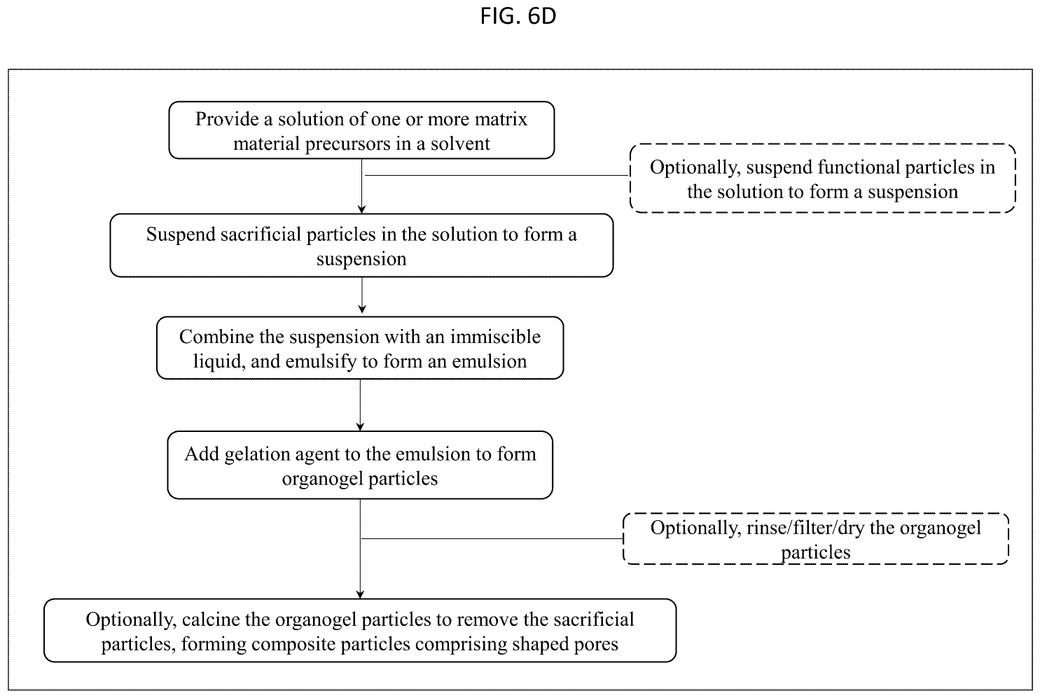

In one aspect, the entirety of the gelation agent is added to the suspension of particles (sacrificial, functional, or both) prior to emulsification. FIG. 6A provides a general, non-limiting flow chart illustrating the method according to such an aspect of the disclosure. With reference to FIG. 6A, in one aspect, the method comprises:
providing a solution of one or more matrix material precursors in a solvent;
suspending sacrificial particles, and optionally functional particles, in the solution to form a suspension;
adding a gelation agent to the suspension, initiating formation of an organogel;
combining the suspension with an immiscible liquid to form a mixture; and
emulsifying the mixture to provide a plurality of droplets and forming organogel particles from each droplet, wherein each droplet in the plurality comprises a plurality of the sacrificial particles.

In another aspect, portions of the gelation agent are added at two separate and distinct points to the suspension of particles (sacrificial, functional, or both). These points are prior to and following emulsification. FIG. 6B provides a general, non-limiting flow chart illustrating the method according to such an aspect of the disclosure. With reference to FIG. 6B, in one aspect, the method comprises:
providing a solution of one or more matrix material precursors in a solvent;
suspending sacrificial particles, and optionally functional particles, in the solution to form a suspension;
adding a portion of a total amount of a gelation agent to the suspension, initiating formation of an organogel;
combining the suspension with an immiscible liquid to form a mixture;
emulsifying the mixture to provide a plurality of droplets, wherein each droplet in the plurality comprises a plurality of the sacrificial particles; and
adding a remainder of the total amount of gelation agent to the emulsified mixture, forming organogel particles from each droplet.

In another aspect, portions of the gelation agent are added at two separate and distinct points. These points are again prior to and following emulsification, but in this scenario, gelation is initiated by addition of the gelation agent prior to addition of the sacrificial particles. FIG. 6C provides a general, non-limiting flow chart illustrating the method according to such an aspect of the disclosure. With reference to FIG. 6C, in one aspect, the method comprises:
providing a solution of one or more matrix material precursors in a solvent;
optionally, suspending functional particles in the solution to form a suspension;
adding a portion of a total amount of a gelation agent to the suspension, initiating formation of an organogel;
suspending sacrificial particles in the solution or suspension;
combining the suspension with an immiscible liquid to form a mixture;
emulsifying the mixture to provide a plurality of droplets, wherein each droplet in the plurality comprises a plurality of the sacrificial particles; and
adding a remainder of the total amount of gelation agent to the emulsified mixture, forming organogel particles from each droplet.

In another aspect, the entirety of the gelation agent is added to the suspension of particles (sacrificial, functional, or both) after to emulsification. FIG. 6D provides a general, non-limiting flow chart illustrating the method according to such an aspect of the disclosure. With reference to FIG. 6D, in one aspect, the method comprises:
providing a solution of one or more matrix material precursors in a solvent;
optionally, suspending functional particles in the solution to form a suspension;
suspending sacrificial particles in the solution or suspension;
combining the suspension with an immiscible liquid to form a mixture;
emulsifying the mixture to provide a plurality of droplets, wherein each droplet in the plurality comprises a plurality of the sacrificial particles; and
adding a gelation agent to the emulsified mixture, forming organogel particles from each droplet.

In each of the foregoing specific aspects and embodiments, it is to be understood that each of the terms (e.g., providing, matrix material and precursors, solvent, sacrificial particles, immiscible liquid, emulsion, and gelation agent) are as described above with respect to the generalized method discussed with reference to FIG. 5. In embodiments in which portions of the gelation agent are separately added, the amount added in each portion relative to the total amount may vary. In some embodiments, the portion is from about 10% to about 50% of the total amount of gelation agent, such as about 10, about 15, about 20, about 25, about 30, about 35, about 40, about 45, or about 50% of the total amount of gelation agent. In some embodiments, the portion is about 25%. In particular embodiments, about 25% of the total amount of gelation agent is added prior to emulsification, with the remaining 75% added following emulsification. In any of the foregoing embodiments, the amount of time which is allowed to elapse between addition of a portion of the gelation agent and the subsequent operation may vary and may be optimized as appropriate but is generally on the order of a few seconds and up to 10 minutes.

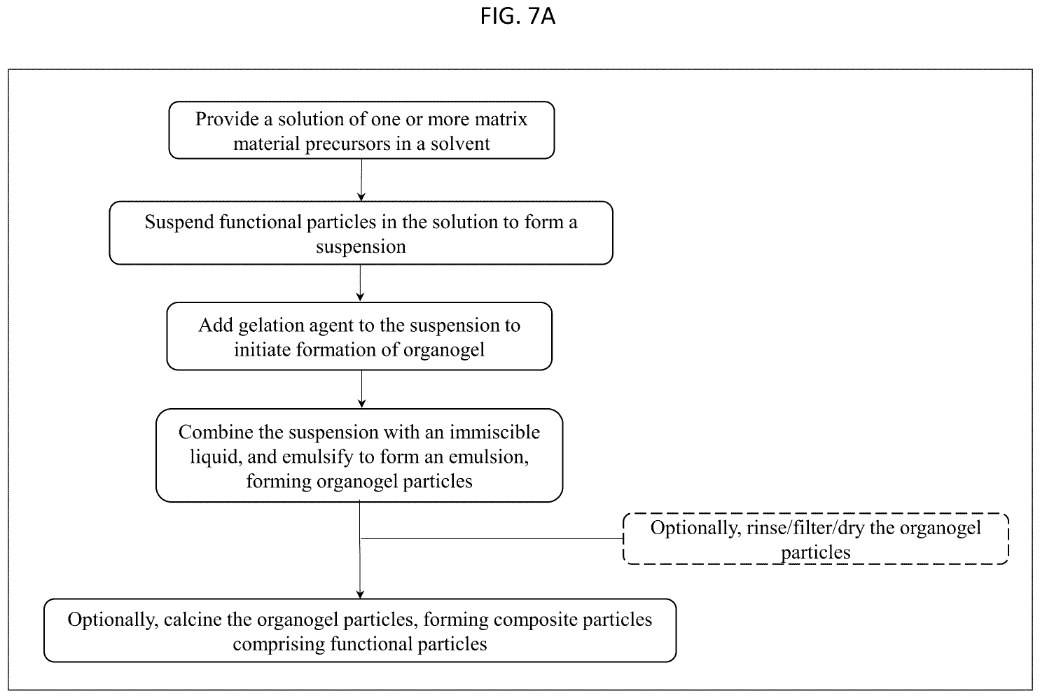

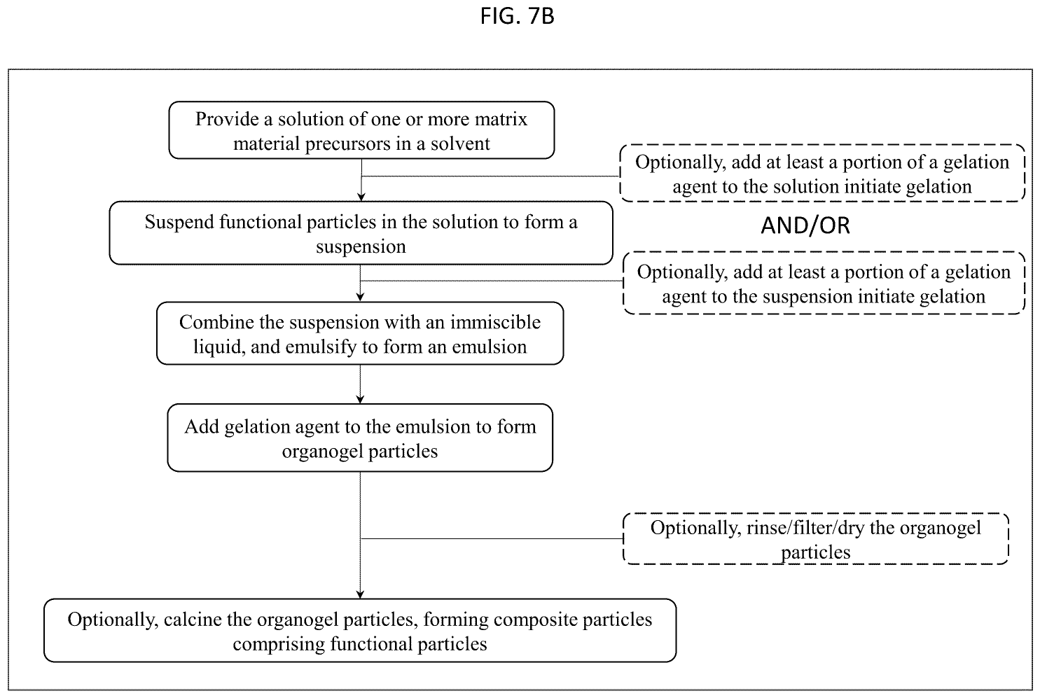

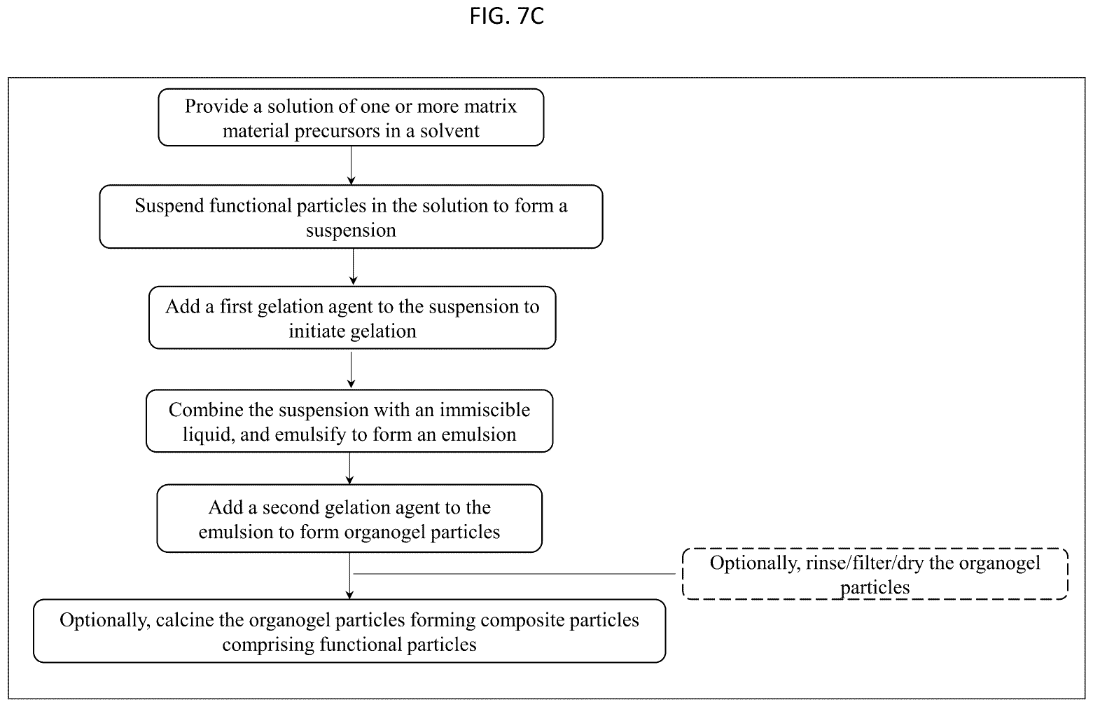

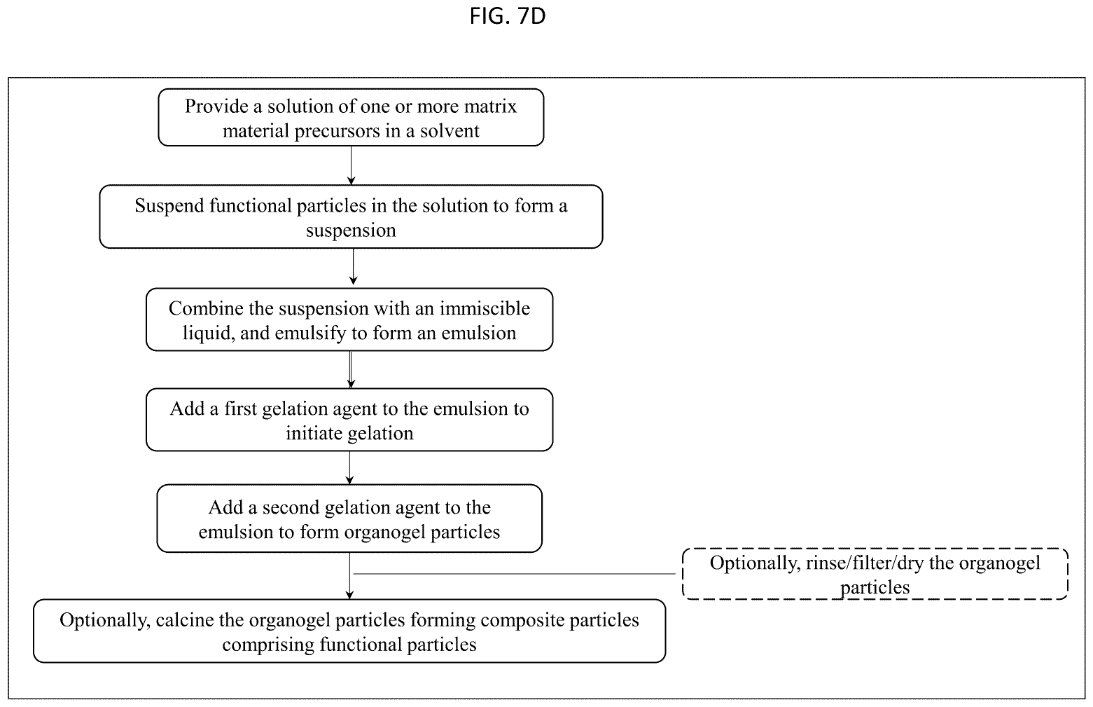

In another aspect, the entirety of the gelation agent is added to a suspension of functional particles (i.e., no sacrificial particles are added) prior to emulsification. FIG. 7A provides a general, non-limiting flow chart illustrating the method according to such an aspect of the disclosure. With reference to FIG. 7A, in one aspect, the method comprises:
providing a solution of one or more matrix material precursors in a solvent;
suspending functional particles in the solution to form a suspension;
adding a gelation agent to the emulsified mixture to initiate gelation;
combining the suspension with an immiscible liquid to form a mixture; and
emulsifying the mixture to provide a plurality of droplets, forming organogel particles from each droplet, wherein each particle in the plurality comprises a plurality of the functional particles.

In the foregoing specific aspect, it is to be understood that each of the terms (e.g., providing, matrix material and precursors, solvent, functional particles, immiscible liquid, emulsion, and gelation agent) are as described above with respect to the generalized method discussed with reference to FIG. 5.

In yet another aspect, at least a portion of the gelation agent is added to the suspension of functional particles after emulsification, and optionally, at least a portion of the gelation agent is added prior to suspension, prior to emulsification, or both. FIG. 7B provides a general, non-limiting flow chart illustrating the method according to such an aspect of the disclosure. With reference to FIG. 7B, in one aspect, the method comprises:
providing a solution of one or more matrix material precursors in a solvent;
optionally, adding at least a portion of a gelation agent to the solution to induce gelation;
suspending functional particles in the solution to form a suspension;
optionally, adding at least a portion of a gelation agent to the suspension to induce gelation;
combining the suspension with an immiscible liquid to form a mixture;
emulsifying the mixture to provide a plurality of droplets, wherein each droplet in the plurality comprises a plurality of the sacrificial particles; and
adding a gelation agent to the emulsified mixture, forming organogel particles from each droplet.

Accordingly, in some embodiments, portions of the gelation agent are separately added, and the amount added in each portion relative to the total amount may vary. In some embodiments, a portion of the gelation agent is added to induce gelation, and the portion is from about 10% to about 50% of a total amount of the gelation agent to be added, such as about 10, about 15, about 20, about 25, about 30, about 35, about 40, about 45, or about 50% of the total amount of gelation agent. In some embodiments, the portion is about 25%. In some embodiments, about 25% of the total amount of gelation agent is added prior to emulsification, with the remaining 75% added following emulsification. In any of the foregoing embodiments, the amount of time which is allowed to elapse between addition of a portion of the gelation agent and the subsequent operation (e.g., suspending, combining, emulsifying) may vary and may be optimized as appropriate, but is generally on the order of a few seconds and up to about 10 minutes.

In the foregoing specific aspect and embodiments, it is to be understood that each of the terms (e.g., providing, matrix material and precursors, solvent, functional particles, immiscible liquid, emulsion, and gelation agent) are as described above with respect to the generalized method discussed with reference to FIG. 5.

In a still further aspect, two different gelation agents are added at different times (i.e., prior to emulsion formation and after emulsion formation). FIG. 7C provides a general, non-limiting flow chart illustrating the method according to such an aspect of the disclosure. With reference to FIG. 7C, in one aspect, the method comprises:
providing a solution of one or more matrix material precursors in a solvent;
suspending functional particles in the solution to form a suspension;
adding a first gelation agent to the suspension to initiate gelation;
combining the suspension with an immiscible liquid to form a mixture;
emulsifying the mixture to provide a plurality of droplets; and
adding a second gelation agent to the emulsion to form organogel particles from each droplet, wherein each particle in the plurality comprises a plurality of the functional particles.

In a yet further aspect, two different gelation agents are added at different times, both of which are after emulsion formation. FIG. 7D provides a general, non-limiting flow chart illustrating the method according to such an aspect of the disclosure. With reference to FIG. 7D, in one aspect, the method comprises:
providing a solution of one or more matrix material precursors in a solvent;
suspending functional particles in the solution to form a suspension;
combining the suspension with an immiscible liquid to form a mixture;
emulsifying the mixture to provide a plurality of droplets;
adding a first gelation agent to the mixture to initiate gelation; and
adding a second gelation agent to the emulsion to form organogel particles from each droplet, wherein each particle in the plurality comprises a plurality of the functional particles.

In the foregoing aspects, it is to be understood that each of the terms (e.g., providing, matrix material and precursors, solvent, functional particles, immiscible liquid, and emulsion) are as described above with respect to the generalized method discussed with reference to FIG. 5.

In some embodiments, the first gelation agent is acetic anhydride, and the second gelation agent is acetic acid. Without wishing to be bound by theory, it is believed that the first gelation agent initiates gelation, forming an outer shell, and the second gelation agent completes the gelation. The amount of each of the first and second gelation agents may vary. For example, in some embodiments, the first gelation agent (e.g., acetic anhydride) is added in an amount less than an amount calculated to be required for complete gelation. In some embodiments, an amount which is from about 10 to about 25% of the required amount for complete gelation is added, such as from about 10, about 11, about 12, about 13, about 14, about 15, or about 16, to about 17, about 18, about 19, about 20, about 21, about 22, about 23, about 24, or about 25% is added. In some embodiments, the amount of the first gelation agent is a stoichiometric amount, or slightly more than a stoichiometric amount calculated as required for complete conversion of polyamic acid to polyimide, or for complete acidification of polyamic acid salt to polyamic acid. In some embodiments, the second gelation agent (e.g., acetic acid) is added in at least a stoichiometric quantity as calculated to be required to complete gelation. In some embodiments, the second gelation agent (e.g., acetic acid) is added in an excess of the stoichiometric quantity, such as in large excess. In some embodiments, the second gelation agent (e.g., acetic acid) is added in an amount of at least twice the required amount, such as 5 times, 10 times, 20 times, or more than the calculated required amount.

### Processing of Organogel Particles

### Aging

In some embodiments, the organogel particles are aged (also referred to as curing). Aging a wet-gel material after it reaches its gel point can further strengthen the gel framework. For example, in some embodiments, the framework may be strengthened during aging. The duration of gel aging can be adjusted to control various properties. This aging procedure can be useful in preventing potential volume loss and shrinkage during e.g., liquid phase extraction of the wet-gel material. Aging can involve maintaining the gel (prior to extraction) at a quiescent state for an extended period; maintaining the gel at elevated temperatures; or any combination thereof. The preferred temperatures for aging are usually between about 10° C. and about 200° C. Aging may also take place during solvent exchange, as described herein below.

### Collecting and Washing

With continued reference to FIG. 5, FIGS. 6A-6D, and FIGS. 7A-7D in some embodiments, the organogel particles are collected (e.g., by filtration), and may be subjected to various washing procedures. For example, the wet organogel particles may be washed or solvent exchanged in a suitable secondary solvent to replace the primary reaction solvent (e.g., water) present in the wet gel. Such secondary solvents may be linear alcohols with 1 or more aliphatic carbon atoms, diols with 2 or more carbon atoms, or branched alcohols, cyclic alcohols, alicyclic alcohols, aromatic alcohols, polyols, ethers, ketones, cyclic ethers or their derivatives. In some embodiments, the secondary solvent is water, a C1 to C3 alcohol (e.g., methanol, ethanol, propanol, isopropanol), acetone, tetrahydrofuran, ethyl acetate, acetonitrile, supercritical fluid carbon dioxide (CO₂), or a combination thereof. In some embodiments, the secondary solvent is ethanol.

### Drying

With continued reference to FIG. 5, FIGS. 6A-6D, and FIGS. 7A-7D, in some embodiments, the organogel particles may be dried. For example, in some embodiments, the liquid phase of the organogel material can then be at least partially extracted from the wet organogel material using extraction methods, including processing and extraction techniques, to form an aerogel material (i.e., “drying”). Liquid phase extraction, among other factors, plays an important role in engineering the characteristics of aerogels, such as porosity and density, as well as related properties such as thermal conductivity. Generally, aerogels are obtained when a liquid phase is extracted from a wet-gel in a manner that causes low shrinkage to the porous network and framework of the wet-gel. Wet gels can be dried using various techniques to provide aerogels or xerogels. In exemplary embodiments, wet-gel materials can be dried at ambient pressure, under vacuum (e.g., through freeze drying), at subcritical conditions, or at supercritical conditions to form the corresponding dry gel (e.g., an aerogel, such as a xerogel).

In some aspect, it may be desirable to fine tune the surface area of the dry gel. If fine tuning of the surface area is desired, aerogels can be converted completely or partially to xerogels with various porosities. The high surface area of aerogels can be reduced by forcing some of the pores to collapse. This can be done, for example, by immersing the aerogels for a certain time in solvents such as ethanol or acetone or by exposing them to solvent vapor. The solvents are subsequently removed by drying at ambient pressure.

Aerogels are commonly formed by removing the liquid mobile phase from the wet-gel material at a temperature and pressure near or above the critical point of the liquid mobile phase. Once the critical point is reached (near critical) or surpassed (supercritical; i.e., pressure and temperature of the system is at or higher than the critical pressure and critical temperature, respectively) a new supercritical phase appears in the fluid that is distinct from the liquid or vapor phase. The solvent can then be removed without introducing a liquid-vapor interface, capillary forces, or any associated mass transfer limitations typically associated with receding liquid-vapor boundaries. Additionally, the supercritical phase is more miscible with organic solvents in general, thus having the capacity for better extraction. Co-solvents and solvent exchanges are also commonly used to optimize the supercritical fluid drying process.

If evaporation or extraction occurs below the supercritical point, capillary forces generated by liquid evaporation can cause shrinkage and pore collapse within the gel material. Maintaining the mobile phase near or above the critical pressure and temperature during the solvent extraction process reduces the negative effects of such capillary forces. In certain embodiments of the present disclosure, the use of near-critical conditions just below the critical point of the solvent system may allow production of aerogels or compositions with sufficiently low shrinkage, thus producing a commercially viable end-product.

Wet organogels of the present disclosure can be dried using various techniques to provide aerogel materials. In example embodiments, wet organogel materials can be dried at ambient pressure, at subcritical conditions, or at supercritical conditions.

Both room temperature and high temperature processes can be used to dry gel materials at ambient pressure. In some embodiments, a slow ambient pressure drying process can be used in which the wet organogel material is exposed to air in an open container for a period of time sufficient to remove solvent, e.g., for a period of time in the range of hours to weeks, depending on the solvent, the quantity of wet organogel material, the exposed surface area, the size of the wet organogel material, and the like.

In another aspect, the wet organogel material is dried by heating. For example, the wet organogel material can be heated in a convection oven for a period of time to evaporate most of the solvent (e.g., ethanol). After partially drying, the gel can be left at ambient temperature to dry completely for a period of time, e.g., from hours to days. This method of drying produces xerogels.

In some embodiments, the wet organogel material is dried by freeze drying. By “freeze drying” or “lyophilizing” is meant a low temperature process for removal of solvent that involves freezing a material (e.g., the wet organogel material), lowering the pressure, and then removing the frozen solvent by sublimation. As water represents an ideal solvent for removal by freeze drying, and water is the solvent in the method as disclosed herein, freeze drying is particularly suited for aerogel formation from the disclosed polyimide wet organogel materials. This method of drying produces cryogels, which may closely resemble aerogels.

Both supercritical and sub-critical drying can be used to dry wet organogel materials. In some embodiments, the wet organogel material is dried under subcritical or supercritical conditions. In an example aspect of supercritical drying, the gel material can be placed into a high-pressure vessel for extraction of solvent with supercritical CO₂. After removal of the solvent, e.g., ethanol, the vessel can be held above the critical point of CO₂ for a period of time, e.g., about 30 minutes. Following supercritical drying, the vessel is depressurized to atmospheric pressure. Generally, aerogels are obtained by this process.

In an example aspect of subcritical drying, the gel material is dried using liquid CO₂ at a pressure in the range of about 800 psi to about 1200 psi at room temperature. This operation is quicker than supercritical drying; for example, the solvent (e.g., ethanol) can be extracted in about 15 minutes. Generally, aerogels are obtained by this process.

Several additional aerogel extraction techniques are known in the art, including a range of different approaches in the use of supercritical fluids in drying aerogels, as well as ambient drying techniques. For example, Kistler (J. Phys. Chem. (1932) 36:52-64) describes a simple supercritical extraction process where the gel solvent is maintained above its critical pressure and temperature, thereby reducing evaporative capillary forces and maintaining the structural integrity of the gel network. U.S. Pat. No. 4,610,863 describes an extraction process where the gel solvent is exchanged with liquid carbon dioxide and subsequently extracted at conditions where carbon dioxide is in a supercritical state. U.S. Pat. No. 6,670,402 teaches extracting a liquid phase from a gel via rapid solvent exchange by injecting supercritical (rather than liquid) carbon dioxide into an extractor that has been pre-heated and pre-pressurized to substantially supercritical conditions or above, thereby producing aerogels. U.S. Pat. No. 5,962,539 describes a process for obtaining an aerogel from a polymeric material that is in the form of a sol-gel in an organic solvent, by exchanging the organic solvent for a fluid having a critical temperature below a temperature of polymer decomposition, and supercritically extracting the fluid from the sol-gel. U.S. Pat. No. 6,315,971 discloses a process for producing gel compositions comprising drying a wet gel comprising gel solids and a drying agent to remove the drying agent under drying conditions sufficient to reduce shrinkage of the gel during drying. U.S. Pat. No. 5,420,168 describes a process whereby resorcinol/formaldehyde aerogels can be manufactured using a simple air-drying procedure. U.S. Pat. No. 5,565,142 describes drying techniques in which the gel surface is modified to be stronger and more hydrophobic, such that the gel framework and pores can resist collapse during ambient drying or subcritical extraction. Other examples of extracting a liquid phase from aerogel materials can be found in U.S. Pat. Nos. 5,275,796 and 5,395,805.

In some embodiments, extracting the liquid phase from the wet organogel material uses supercritical conditions of carbon dioxide, including, for example: first substantially exchanging the primary solvent present in the pore network of the gel with liquid carbon dioxide; and then heating the wet gel (typically in an autoclave) beyond the critical temperature of carbon dioxide (about 31.06° C.) and increasing the pressure of the system to a pressure greater than the critical pressure of carbon dioxide (about 1070 psig). The pressure around the gel material can be slightly fluctuated to facilitate removal of the supercritical carbon dioxide fluid from the gel. Carbon dioxide can be recirculated through the extraction system to facilitate the continual removal of the primary solvent from the wet gel. Finally, the temperature and pressure are slowly returned to ambient conditions to produce a dry aerogel material. Carbon dioxide can also be pre-processed into a supercritical state prior to being injected into an extraction chamber. In other embodiments, extraction can be performed using any suitable mechanism, for example altering the pressures, timings, and solvent discussed above.

### Calcining

With continued reference to FIG. 5, FIGS. 6A-6D, and FIGS. 7A-7D, in some embodiments, the method further comprises calcining the organogel (e.g., an organic aerogel). As used herein, the term “calcining” is used synonymously with “pyrolysis” or “carbonization” and refers to the decomposition or transformation of an organic compound or composition to pure or substantially pure carbon caused by heat. In some embodiments, dried organogel particles as disclosed herein (e.g., polyimide xerogel or aerogel particles) are heated at a temperature and for a time sufficient to convert substantially all of the organogel matrix material into carbon. The time and temperature required may vary. In some embodiments, the dried organogel (e.g., aerogel or xerogel) particles are subjected to a treatment temperature of 400° C. or above, 600° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the organogel matrix material. Generally, the calcining is conducted under an inert atmosphere to prevent combustion of the matrix material (either organic or carbon resulting from organogel decomposition). Suitable atmospheres include, but are not limited to, nitrogen, argon, or combinations thereof. In some embodiments, calcining is performed under nitrogen.

In some embodiments, the calcining isomorphically converts substantially all of the organogel matrix material to carbon. In some embodiments, the calcining substantially removes the sacrificial particles, forming shaped pores.

In some embodiments, the functional particles comprise a sacrificial coating, and the calcining substantially removes the sacrificial coating, forming void spaces around the functional particles. In some embodiments, following calcining, the composite particles are essentially free of sacrificial particle- or sacrificial coating-related residue.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed. No language in the specification should be construed as indicating any non-claimed element as essential to the practice of the disclosed materials and methods.

It will be readily apparent to one of ordinary skill in the relevant arts that suitable modifications and adaptations to the compositions, methods, and applications described herein can be made without departing from the scope of any embodiments or embodiments thereof. The compositions and methods provided are exemplary and are not intended to limit the scope of the claimed embodiments. All of the various embodiments, embodiments, and options disclosed herein can be combined in all variations. The scope of the compositions, formulations, methods, and processes described herein include all actual or potential combinations of embodiments, embodiments, options, examples, and preferences herein.

Although the technology herein has been described with reference to particular embodiments, it is to be understood that these embodiments are merely illustrative of the principles and applications of the present technology. It will be apparent to those skilled in the art that various modifications and variations can be made to the method and apparatus of the present technology without departing from the spirit and scope of the technology. Thus, it is intended that the present technology include modifications and variations that are within the scope of the appended claims and their equivalents.

Reference throughout this specification to “one embodiment,” “certain embodiments,” “one or more embodiments” or “an embodiment” means that a particular feature, structure, material, or characteristic described in connection with the embodiment is included in at least one embodiment of the technology. Thus, the appearances of phrases such as “in one or more embodiments,” “in certain embodiments,” “in one embodiment” or “in an embodiment” in various places throughout this specification are not necessarily referring to the same embodiment of the technology. Furthermore, the particular features, structures, materials, or characteristics may be combined in any suitable manner in one or more embodiments. Any ranges cited herein are inclusive.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference should be disregarded.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Embodiments of the present technology are more fully illustrated with reference to the following examples. w Before describing several exemplary embodiments of the technology, it is to be understood that the technology is not limited to the details of construction or process steps set forth in the following description. The technology is capable of other embodiments and of being practiced or being carried out in various ways. The following examples are set forth to illustrate certain embodiments of the present technology and are not to be construed as limiting thereof.

### EXEMPLIFICATION

The present invention may be further illustrated by the following non-limiting examples describing the methods. The following examples are described for illustrative purposes only and are not intended to be limiting the scope of the various embodiments of the current invention in any way.

### Example 1: Preparation of Composite Particles Comprising Shaped Pores (Option 1)

Composite particles comprising shaped pores were prepared from a polyimide organogel according to a method in which the entirety of the gelation agent (acetic anhydride) is added just prior to emulsion formation.

Generally, p-phenylenediamine (PDA; 12.7 g) was added to water (313 g) in a beaker and stirred for 30 min until all the PDA was dissolved. Triethylamine (28.5 g) was then added to the solution and stirred for 10 min, following which benzene-1,2,4,5-tetracarboxylic anhydride (25.5 g) was added to the solution and stirred for 4 h. Sacrificial particles (e.g., polymethylmethacrylate nanospheres; PMMA; 1.5-25 g) and optionally, functional particles (e.g., surface oxidized and optionally surface modified Si particles; 14.4 g) were then added to the solution and stirred for 10 min. To induce gelation, acetic anhydride (51.4 g) was then poured into the suspension and stirred for 50 seconds before pouring the suspension into 1200 mL of mineral spirits containing a surfactant while mixing at 3600 rpm. The obtained emulsion was then aged overnight before collecting the composite beads by filtration. The obtained beads were then rinsed with ethanol several times and oven dried at 70° C. The final composite particles were obtained by calcining the dried particles at a temperature in a range from about 800-1200° C. under inert atmosphere (N₂ or Ar) for 2-10 h. The carbon beads had a surface area of 0.15 m²/g. Without wishing to be bound by theory, it is believed that this low surface area is the result of rapid gelation of the exterior of the particle surface, followed by more gradual gelation from the outside inward. This lower surface area may lead to higher first cycle efficiency and longer cycle life when used in batteries.

### Example 2: Preparation of Composite Particles Comprising Shaped Pores (Option 2)

Composite particles comprising shaped pores were prepared from a polyimide organogel according to a method in which a portion (approximately 25%) of the gelation agent (acetic anhydride) is added just prior to emulsion formation, and the remaining gelation agent is added following initial emulsification.

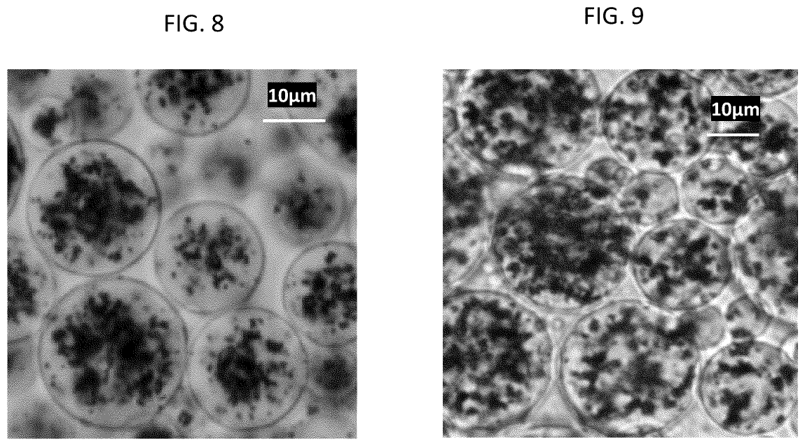

Generally, p-phenylenediamine (PDA; 12.7 g) was added to water (313 g) in a beaker and stirred for 30 min until all the PDA was dissolved. Triethylamine (28.5 g) was then added to the solution and stirred for 10 min, following which benzene-1,2,4,5-tetracarboxylic anhydride (25.5 g) was added to the solution and stirred for 4 h. Sacrificial particles (e.g., polymethylmethacrylate nanospheres; PMMA; 1.5-25 g) and optionally, functional particles (e.g., oxidized Si particles; 14.4 g) were then added to the solution and stirred for 10 min. To induce gelation, acetic anhydride (12.9 g; 25% of total amount) was then poured into the suspension and stirred for 50 seconds before pouring the suspension into 1200 mL of mineral spirits containing a surfactant while mixing at 3600 rpm. After 60 seconds, the remaining quantity of acetic anhydride (38.55 g; 75%) was added to the emulsion with continued mixing, and the mixing was stopped after 3 minutes. The obtained emulsion was then aged overnight before collecting the composite beads by filtration. The obtained beads were then rinsed with ethanol several times and oven dried at 70° C. The final composite particles were obtained by calcining the dried particles at a temperature in a range from about 800-1200° C. under inert atmosphere (N₂ or Ar) for 2-10 h. As in Example 1, the surface area of the carbon beads remained low at 24 m²/g. A photomicrograph of representative beads is provided as FIG. 8.

### Example 3: Preparation of Composite Particles Comprising Shaped Pores (Option 3)

Composite particles comprising shaped pores were prepared from a polyimide organogel according to a method in which a portion (approximately 25%) of the gelation agent (acetic anhydride) is added just prior to emulsion formation, and the remaining gelation agent is added following initial emulsification. According to this method, sacrificial particles are added following addition of the initial portion of gelation agent.

Generally, p-phenylenediamine (PDA; 12.7 g) was added to water (313 g) in a beaker and stirred for 30 min until all the PDA was dissolved. Triethylamine (28.5 g) was then added to the solution and stirred for 10 min, following which benzene-1,2,4,5-tetracarboxylic anhydride (25.5 g) was added to the solution and stirred for 4 h. Optionally, functional particles (e.g., oxidized Si particles; 14.4 g) were added to the solution and stirred for 10 min. To induce gelation, acetic anhydride (12.9 g; 25% of total amount) was then poured into the suspension and stirred for 30 seconds before sacrificial particles (e.g., polymethylmethacrylate nanospheres; PMMA; 1.5-25 g) were added. After stirring for 50 seconds, the suspension was poured into 1200 mL of mineral spirits containing a surfactant while mixing at 3600 rpm. After 60 seconds, the remaining quantity of acetic anhydride (38.55 g; 75%) was added to the emulsion with continued mixing, and the mixing was stopped after 3 minutes. The obtained emulsion was then aged overnight before collecting the composite beads by filtration. The obtained beads were then rinsed with ethanol several times and oven dried at 70° C. The final composite particles were obtained by calcining the dried particles at a temperature in a range from about 800-1200° C. under inert atmosphere (N₂ or Ar) for 2-10 h. As in Example 1, the surface area of the carbon beads remained low at 0.26 m²/g.

### Example 4: Preparation of Composite Particles Comprising Shaped Pores (Option 4)

Composite particles comprising shaped pores were prepared from a polyamic acid organogel according to a method in which the gelation agent (acetic acid) is added after emulsion formation.

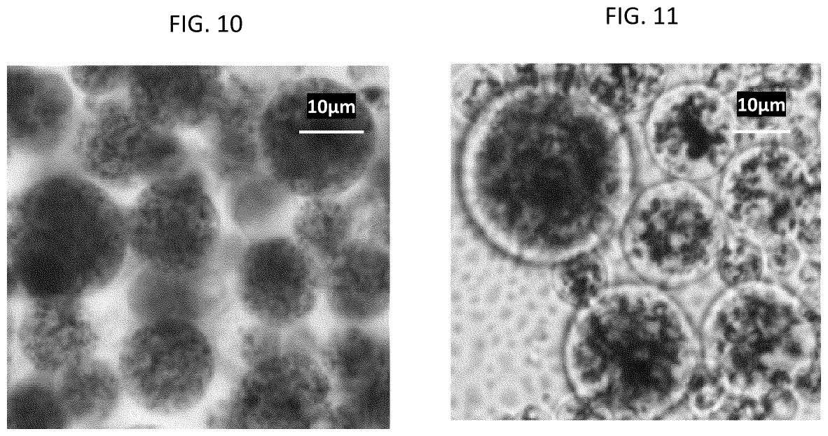

Generally, p-phenylenediamine (PDA; 12.7 g) was added to water (313 g) in a beaker and stirred for 30 min until all the PDA was dissolved. Triethylamine (28.5 g) was then added to the solution and stirred for 10 min, following which benzene-1,2,4,5-tetracarboxylic anhydride (25.5 g) was added to the solution and stirred for 4 h. Optionally, functional particles (e.g., oxidized Si particles; 14.4 g) were added to the solution and stirred for 10 min. Sacrificial particles (e.g., polymethylmethacrylate nanospheres; PMMA; 1.5-25 g) were then added to the suspension and stirred for 10 min. The suspension was poured into 1200 mL of mineral spirits containing a surfactant while mixing at 3600 rpm for 4 minutes. The stirring was then slowed to 400 rpm, and to induce gelation, acetic acid (300 mL) was then poured into the emulsion and stirred for 5 minutes. The obtained emulsion was then aged overnight before collecting the composite beads by filtration. The obtained beads were then rinsed with ethanol several times and oven dried at 70° C. The final composite particles were obtained by calcining the dried particles at a temperature in a range from about 800-1200° C. under inert atmosphere (N₂ or Ar) for 2-10 h. Over several runs, the carbon beads had an average surface area of about 63 m²/g across four experiments, with the runs providing average surface areas of about 18, 32, 98, and 106 m²/g. Without wishing to be bound by theory, it is believed that this high surface area is the result of rapid gelation, pushing more functional particles toward the outer surface. Photomicrographs of representative beads are provided as FIGS. 9 and 10.

### Example 5: Preparation of Composite Particles (Option 1)

Composite particles were prepared from a polyimide organogel according to a method in which the entirety of the gelation agent (acetic anhydride) is added just prior to emulsion formation.

Generally, p-phenylenediamine (PDA; 12.7 g) was added to water (313 g) in a beaker and stirred for 30 min until all the PDA was dissolved. Triethylamine (28.5 g) was then added to the solution and stirred for 10 min, following which benzene-1,2,4,5-tetracarboxylic anhydride (PMDA; 25.5 g) was added to the solution and stirred for 4 h. Functional particles (e.g., surface oxidized and optionally surface modified Si particles; 14.4 g) were then added to the solution and stirred for 10 min. No sacrificial particles were added to solution. To induce gelation, acetic anhydride (51.4 g) was then poured into the suspension and stirred for 50 seconds before pouring the suspension into 1200 mL of mineral spirits containing a surfactant while mixing at 3600 rpm. The obtained emulsion was then aged overnight before collecting the composite beads by filtration. The obtained beads were then rinsed with ethanol several times and oven dried at 70° C. The final composite particles were obtained by calcining the dried particles at a temperature in a range from about 800-1200° C. under inert atmosphere (N₂ or Ar) for 2-10 h. Over several runs, the carbon beads had an average surface area of about 29 m²/g, with average values from three experiments of about 2, about 22, and about 32 m²/g. A photomicrograph of representative beads is provided as FIG. 11.

### Example 6: Preparation of Composite Particles (Option 2)

Composite particles were prepared from a polyamic acid organogel according to a method in which the gelation agent (acetic acid) is added after emulsion formation.

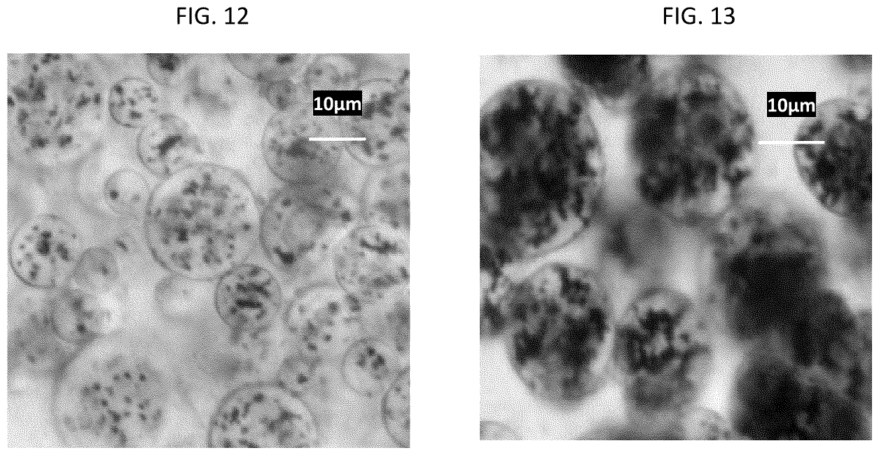

Generally, p-phenylenediamine (PDA; 12.7 g) was added to water (313 g) in a beaker and stirred for 30 min until all the PDA was dissolved. Triethylamine (28.5 g) was then added to the solution and stirred for 10 min, following which benzene-1,2,4,5-tetracarboxylic anhydride (PMDA; 25.5 g) was added to the solution and stirred for 4 h. Functional particles (e.g., oxidized Si particles; 14.4 g) were added to the solution and stirred for 10 min. No sacrificial particles were added to solution. The suspension was poured into 1200 mL of mineral spirits containing a surfactant while mixing at 3600 rpm for 4 minutes. The stirring was then slowed to 400 rpm, and to induce gelation, acetic acid (300 mL) was poured into the emulsion and stirred for 5 minutes. The obtained emulsion was then aged overnight before collecting the composite beads by filtration. The obtained beads were then rinsed with ethanol several times and oven dried at 70° C. The final composite particles were obtained by calcining the dried particles at a temperature in a range from about 800-1200° C. under inert atmosphere (N₂ or Ar) for 2-10 h. The carbon beads had a surface area of 0.32 m²/g. A photomicrograph of representative beads is provided as FIG. 12.

### Example 7: Preparation of Composite Particles (Option 3)

Composite particles were prepared from a hybrid polyimide/polyamic acid organogel according to a method in which one gelation agent (acetic anhydride) is added at a low concentration (10-25%) just prior to emulsion formation and a second gelation agent (acetic acid) is added after emulsion formation.

Generally, p-phenylenediamine (PDA; 12.7 g) was added to water (313 g) in a beaker and stirred for 30 min until all the PDA was dissolved. Triethylamine (28.5 g) was then added to the solution and stirred for 10 min, following which benzene-1,2,4,5-tetracarboxylic anhydride (PMDA; 25.5 g) was added to the solution and stirred for 4 h. Functional particles (e.g., oxidized Si particles; 14.4 g) were added to the solution and stirred for 10 min. No sacrificial particles were added to solution. To induce partial gelation, a first gelation agent (acetic anhydride; 12.9 g; 0.25 molar equivalent) was then poured into the suspension and stirred for 30 seconds. After stirring for 50 seconds, the suspension was poured into 1200 mL of mineral spirits containing a surfactant while mixing at 3600 rpm. After 4 minutes, the stirring was slowed to 400 RPM and the second gelation agent (acetic acid, 300 mL) was added to the emulsion to complete gelation and stirred for 5 minutes. The obtained emulsion was then aged overnight before collecting the composite beads by filtration. The obtained beads were then rinsed with ethanol several times and oven dried at 70° C. The final composite particles were obtained by calcining the dried particles at a temperature in a range from about 800-1200° C. under inert atmosphere (N₂ or Ar) for 2-10 h. The carbon beads had an average surface area of about 29 m²/g across two experiments, with one run providing beads of about 0.5 m²/g, and a second run providing beads of about 12 m²/g. A photomicrograph of representative beads is provided as FIG. 13.

### Example 8: Preparation of Composite Particles (Option 4)

Composite particles were prepared from a hybrid polyimide/polyamic acid organogel according to a method in which a first gelation agent (acetic anhydride) is added at a low concentration (10-25% of the typical amount disclosed herein above) during the emulsion formation and a second gelation agent (acetic acid) is added after emulsion formation. Generally, p-phenylenediamine (PDA; 12.7 g) was added to water (313 g) in a beaker and stirred for 30 min until all the PDA was dissolved. Triethylamine (28.5 g) was then added to the solution and stirred for 10 min, following which benzene-1,2,4,5-tetracarboxylic anhydride (PMDA; 25.5 g; 117 mmol) was added to the solution and stirred for 4 h. Optionally, functional particles (e.g., oxidized Si particles; 14.4 g) were added to the solution and stirred for 10 min. To obtain collapsed pores during the process, no sacrificial particles were added to solution. The suspension was poured into 1200 mL of mineral spirits containing a surfactant while mixing at 3600 rpm. To induce partial gelation, acetic anhydride (12.9 g; 126 mmol) was then poured into the emulsion. After 4 minutes, the stirring was slowed to 400 RPM and the second gelation agent (acetic acid, 300 mL) was added to the emulsion to complete gelation and stirred for 5 minutes. The obtained emulsion was then aged overnight before collecting the composite beads by filtration. The obtained beads were then rinsed with ethanol several times and oven dried at 70° C. The final composite particles were obtained by calcining the dried particles at a temperature in a range from about 800-1200° C. under inert atmosphere (N₂ or Ar) for 2-10 h. The carbon beads had a surface area of 17 m²/g.

What is claimed is:

1. A method of preparing composite particles comprising a matrix material and a plurality of functional particles disposed within the matrix material, and wherein the composite particles comprise an exterior surface region, the method comprising:
providing a solution of one or more matrix material precursors in a solvent;
suspending functional particles in the solution to form a suspension;
adding a first gelation agent to the solution, initiating formation of an organogel;
combining the suspension with an immiscible liquid to form a mixture;
emulsifying the mixture to provide a plurality of droplets, wherein each droplet in the plurality comprises a plurality of the functional particles;
adding a second gelation agent to the solution, continuing formation of the organogel; and
optionally, drying the organogel particles.

2. The method of claim 1, wherein the functional particles are electrochemically active.

3. The method of claim 2, wherein the functional particles comprise silicon, germanium, tin, or a combination thereof.

4. The method of claim 1, wherein the immiscible liquid is mineral spirits or a silicone oil.

5. The method of claim 1, wherein the organogel comprises a polyamic acid, a polyimide, or a combination thereof.

6. The method of claim 5, wherein the first gelation agent is acetic anhydride and the second gelation agent is acetic acid.

7. The method of claim 6, wherein the composite particles comprise a central region extending from a center of the composite particle outward toward the exterior surface region, wherein the central region comprises more functional particles than the exterior surface region.

8. The method of claim 6, wherein the first gelation agent creates a viscosity gradient within the droplets, and wherein the viscosity gradient forces functional particles toward a center of the droplets, such that the exterior surface region of the composite particles has a deficit of functional particles relative to the central region.

9. The method of claim 1, further comprising calcining the organogel particles under an inert atmosphere at a temperature of at least about 650° C.

10. The method of claim 9, wherein the calcining isomorphically converts substantially all of the organogel to carbon.

11. The method of claim 1, wherein the exterior surface region has a thickness in a range from about 0.1% to about 25% of a diameter of the composite particles.

12. The method of claim 1, wherein a thickness of the exterior surface region varies along an exterior surface of the composite particle.

13. The method of claim 1, wherein the composite particle comprises surface depressions projecting from an outer surface of the particle into the exterior surface region, and wherein said surface depressions comprise one or more functional particles.
